(19) United States
(12) Patent Application Publication
(10) Pub. No.: US 2014/0089513 A1
(43) Pub. Date: Mar. 27, 2014

(54) WIRELESS COMMUNICATION APPARATUS AND METHOD

(71) Applicant: KABUSHIKI KAISHA TOSHIBA, Tokyo (JP)

(72) Inventors: Tomoko ADACHI, Kawasaki-shi (JP); Tomoya TANDAI, Tokyo (JP); Ryoko MATSUO, Tokyo (JP)

(21) Appl. No.: 14/034,319

(22) Filed: Sep. 23, 2013

(30) Foreign Application Priority Data
Sep. 25, 2012 (JP) 2012-210288
Sep. 19, 2013 (JP) 2013-194568

(51) Int. Cl. H04W 76/02

(52) U.S. Cl. CPC H04W 76/02
USPC 709/227

(57) ABSTRACT

According to one embodiment, a wireless communication apparatus includes a first and a second processing unit. The first processing unit generates a control signal related to connection settings. The second processing unit supports wireless systems and is configured to transmit a first frame including first information related to at least one of the plurality of wireless systems by any of the wireless systems, grasp, based on a second frame received from another wireless communication apparatus, a wireless system supported by the other wireless communication apparatus, select a wireless system used for data exchange with the other wireless communication apparatus based on the second information indicating the grasped wireless system.

### CROSS REFERENCE TO RELATED APPLICATIONS

This application is based upon and claims the benefit of priority from Japanese Patent Applications No. 2012-210288, filed Sep. 25, 2012; No. 2013-194568, filed Sep. 19, 2013, the entire contents of all of which are incorporated herein by reference.

### FIELD

Embodiments described herein relate generally to a wireless communication apparatus and method.

### BACKGROUND

A communication system is known in which an upper layer of the physical layer corresponds to the data link layer (second layer in the OSI reference model) and the transport layer (fourth layer in the OSI reference model) and the upper layer establishes connection to another wireless communication apparatus after receiving a trigger signal to start processing related to connection settings from the higher session layer (fifth layer of the OSI reference model). This communication system assumes the use of one wireless system.

On the other hand, wireless communication apparatuses supporting a plurality of wireless systems are known. When such a wireless communication apparatus is realized by using the above communication system, because the session layer is not involved in the wireless system, a problem arises that lower layers cannot be controlled by adding information about the wireless system to the trigger signal from the session layer. Further, the above communication system assumes the use of one wireless system and thus, there is no method for a lower layer receiving the trigger signal from the session layer to decide the wireless system used for communication. Therefore, being able to decide an appropriate wireless system used for communication with another wireless communication apparatus is required for a wireless communication apparatus adopting the above communication system and supporting a plurality of wireless systems.

### BRIEF DESCRIPTION OF THE DRAWINGS

FIG. 1 is a block diagram schematically showing a wireless communication apparatus according to a first embodiment;

FIG. 2 is a conceptual diagram showing an example of wireless communication according to the first embodiment;

FIG. 3 is a diagram illustrating an example of connection processing between wireless communication apparatuses according to the first embodiment;

FIG. 4 is a diagram showing an example of a frame format of a management frame according to the first embodiment;

FIG. 5 is a conceptual diagram showing another example of wireless communication according to the first embodiment;

FIG. 6 is a diagram illustrating another example of connection processing between wireless communication apparatuses according to the first embodiment;

FIG. 7 is a diagram illustrating still another example of connection processing between wireless communication apparatuses according to the first embodiment;

FIG. 8 is a diagram illustrating an example of connection processing between wireless communication apparatuses according to a fourth embodiment;

FIG. 9 is a diagram illustrating another example of connection processing between wireless communication apparatuses according to the fourth embodiment;

FIG. 10 is a diagram illustrating still another example of connection processing between wireless communication apparatuses according to the fourth embodiment;

FIG. 11 is a diagram showing an example of a frame body of a management frame according to a fifth embodiment;

FIG. 12 is a diagram illustrating an example of connection processing between wireless communication apparatuses according to a seventh embodiment;

FIG. 13 is a diagram illustrating another example of connection processing between wireless communication apparatuses according to the seventh embodiment;

FIG. 14 is a block diagram schematically showing a wireless communication apparatus according to a ninth embodiment;

FIG. 15 is a block diagram schematically showing a wireless communication apparatus according to a tenth embodiment; and

FIG. 16 is a block diagram schematically showing a wireless communication apparatus according to an eleventh embodiment.

### DETAILED DESCRIPTION

In general, according to one embodiment, a wireless communication apparatus comprises a first processing unit and a second processing unit. The first processing unit is configured to accept input of application data and generate a first control signal related to connection settings and transmission data based on the application data. The second processing unit supports a plurality of wireless systems and is configured to generate a first frame related to connection processing based on a state in connection processing procedure when the first control signal is received from the first processing unit, the first frame being a frame which includes first information related to at least one of the plurality of wireless systems and in which a transmission destination is set based on the first control signal, transmit the first frame by any of the plurality of wireless systems, grasp, based on a second frame related to connection processing received from another wireless communication apparatus, a wireless system supported by the other wireless communication apparatus, hold second information indicating the grasped wireless system, output a second control signal indicating reception of the second frame to the first processing unit, select a wireless system to be used for data exchange with the other wireless communication apparatus from the plurality of wireless systems based on the second information after completion of the connection processing procedure, generate a data frame containing the transmission data, and transmit the data frame by the selected wireless system.

Hereinafter, wireless communication apparatuses and methods according to various embodiments will be described with reference to the accompanying drawings. The embodiments described herein relate to wireless communication apparatuses supporting a plurality of wireless systems (wireless communication systems). A wireless communication apparatus supporting a plurality of wireless systems is also referred to as a combo apparatus. In the embodiments below, examples using TransferJet (registered trademark) defined by Standard ECMA-398 and a wireless system drawn up by modifying Standard ECMA-398 are mainly described, but available wireless systems are not limited to these. TransferJet is a near field communication system for point-to-point communication.

In the embodiments, elements which are the same as or similar to described elements are hereinafter denoted by the same or similar reference numerals, with duplicate descriptions basically omitted.

### First Embodiment

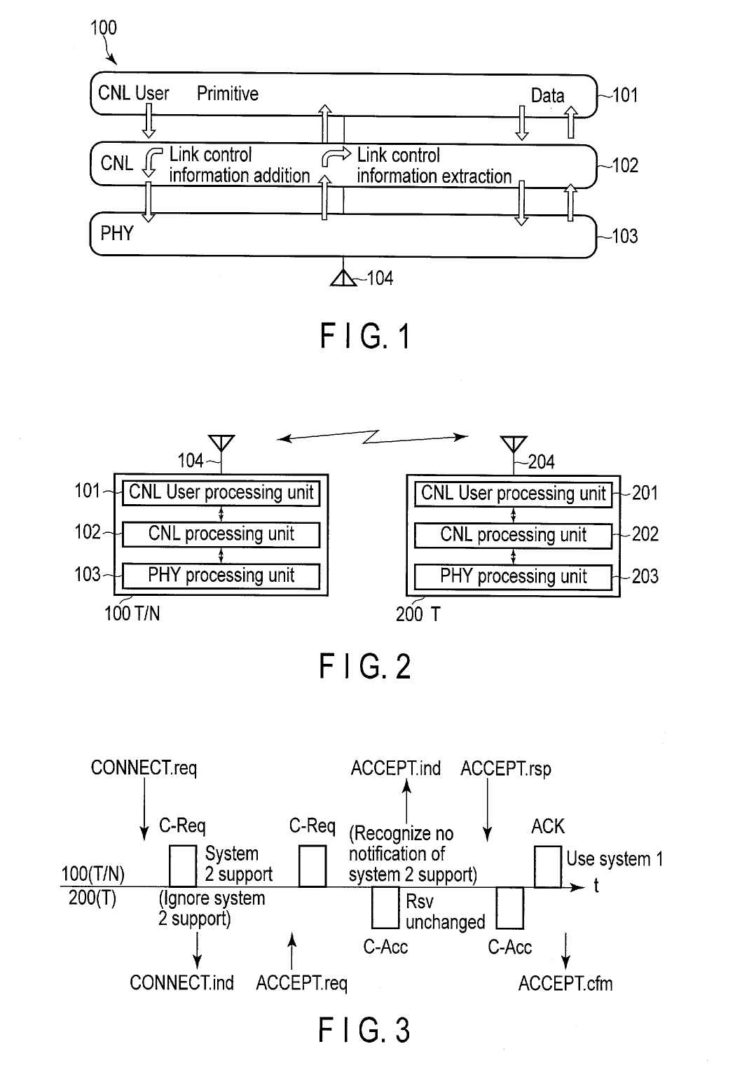

FIG. 1 schematically shows a layer structure of a wireless communication apparatus 100 according to a first embodiment. As shown in FIG. 1, the wireless communication apparatus 100 includes a CNL (CoNnection Layer) User processing unit 101, a CNL processing unit 102, a PHY (PHYsical layer) processing unit 103, and an antenna 104 connected to the PHY processing unit 103. The CNL User processing unit 101 corresponds to, for example, the fifth layer (that is, the session layer) of the OSI reference model, the CNL processing unit 102 corresponds to the second layer (that is, the data link layer) and the fourth layer (that is, the transport layer) of the OSI reference model, and the PHY processing unit 103 corresponds to the first layer (that is, the physical layer) of the OSI reference model.

In the present embodiment, a wireless communication apparatus is assumed to support a plurality of wireless systems for point-to-point communication like TransferJet and thus, the CNL processing unit 102 does not include the third layer (that is, the network layer) of the OSI reference model. However, the layer structure of a wireless communication apparatus is not limited to the example described in the present embodiment and can be designed in accordance with the wireless systems supported by a wireless communication apparatus allowing the CNL processing unit 102 to correspond to the second, third, and fourth layers in another instance.

While the CNL processing unit 102 and the PHY processing unit 103 handle the wireless system, the CNL User processing layer 101 is a layer not involved in the wireless system. The CNL User processing unit 101 accepts input of application data generated by an application operation of a user or another program, generates a start instruction of connection settings based on the application data, and outputs the start instruction of connection settings to the CNL processing unit 102 which is a lower layer thereof. When a signal related to connection settings is received from another wireless communication apparatus via the CNL processing unit 102, the CNL User processing unit 101 outputs a start instruction of connection settings to the CNL processing unit 102 in response to the signal. After the connection to the other wireless communication apparatus is established via the CNL processing unit 102, the CNL User processing unit 101 subsequently converts the application data into data to be transmitted to the other wireless communication apparatus and outputs the data to the CNL processing unit 102.

In the present embodiment, the CNL processing unit 102 and the PHY processing unit 103 support a plurality of wireless systems. Even if, as will be described below, wireless systems can be actually distinguished at the PHY processing unit 103, the CNL processing unit 102 is also considered to support the plurality of wireless systems in a sense that the CNL processing unit 102 uses different wireless systems of the PHY processing unit 103 properly in the present embodiment.

The term “connection” used herein refers to a state in which after a physical communication path is established between one apparatus and another apparatus, data can be exchanged on the communication path. In the present embodiment, a wireless communication apparatus is considered as an apparatus and thus, “connection” refers to a state in which one wireless communication apparatus can exchange data with another wireless communication apparatus over a wireless medium via the data link layer and the physical layer. In the processing to set the connection, information about wireless systems of both wireless communication apparatuses (for example, detailed information of wireless systems supported by each of the wireless communication apparatuses) is exchanged and roles of each of the wireless communication apparatuses are determined. To take TransferJet as an example, the determination of roles is processing to determine which of the wireless communication apparatuses is to become an initiator having priority in transmitting in point-to-point communication and which of the wireless communication apparatuses is to become a responder which is the other role. Here, information exchanged with another wireless communication apparatus for connection settings is called link control information. Also, frames transmitted to another wireless communication apparatus to make connection settings are a type of management frame. For example, a C-Req frame and a C-Acc frame described below correspond to the management frame. Further, a frame that carries data to be transmitted to another wireless communication apparatus after connection establishment is called a data frame. Furthermore, an ACK (ACKnowledgement) frame transmitted from a wireless communication apparatus having received a frame to the source wireless communication apparatus to make a notification of acknowledgement of a management frame or data frame is a type of control frame. The frame types of the management frame, data frame, and control frame can be distinguished by a header portion of the frame.

To simplify the description, the wireless communication apparatus 100 in the present embodiment is assumed to support two wireless systems; a wireless system 1 and a wireless system 2. The wireless system 1 is, for example, a wireless system defined by Standard ECMA-398. In the present embodiment, the system is denoted conveniently by “TransferJet”, “T-Jet”, or simply “T”. The wireless system 2 is, for example, a wireless system made faster by extending the modulation and coding schemes (for example, by increasing the modulation level) defined in Standard ECMA-398. TransferJet uses BPSK (Binary Phase Shift Keying) and DSSS (Direct Sequence Spread Spectrum) and has data rates of 32 Mbps, 65 Mbps, 130 Mbps, 261 Mbps, and 522 Mbps. As an example, the wireless system 2 introduces QPSK (Quadrature Phase Shift Keying) as the modulation method, instead of BPSK. In such a case, the wireless system 1 and the wireless system 2 use the same frequency band (microwave band). Like the wireless system 1, the wireless system 2 may offer variations of a plurality of data rates. The wireless systems here may be those systems distinguished based on generational elements, instead of the resolution on data rates. That is, the wireless systems are distinguished by gradable levels at which recognition can be expected to match that of a partner wireless communication apparatus without making any detailed notification in the process of connection processing on purpose. In the present embodiment, the wireless system 2 is denoted by “N T-Jet” or simply “N” conveying the meaning of Next Generation TransferJet.

The wireless communication apparatus 100 in the present embodiment is a combo apparatus supporting both of the wireless system 1 and the wireless system 2. On the other hand, a combo apparatus supporting the wireless system 1 and the wireless system 2 or a wireless communication apparatus supporting only the wireless system 1 can be assumed as the wireless communication apparatus of a communication party. A wireless communication apparatus supporting only the wireless system 2 can also be assumed, but a wireless communication apparatus supporting only the wireless system 1 in the first generation and a combo apparatus supporting the wireless system 2 in the second generation and having backward compatibility with the first generation will be considered here.

FIG. 2 shows a state in which a wireless communication apparatus (combo apparatus) 100 supporting both of the wireless system 1 in the first generation and the wireless system 2 in the second generation and a wireless communication apparatus 200 supporting only the wireless system 1 in the first generation communicate. As shown in FIG. 2, the wireless communication apparatus 200 includes a CNL User processing unit 201, a CNL processing unit 202, a PHY processing unit 203, and an antenna 204 connected to the PHY processing unit 203. The CNL User processing unit 201, the CNL processing unit 202, the PHY processing unit 203, and the antenna 204 correspond to the CNL User processing unit 101, the CNL processing unit 102, the PHY processing unit 103, and the antenna 104, respectively, except that the CNL processing unit 202 and the PHY processing unit 203 conform to the wireless system 1 only. While different reference numbers are attached to the CNL User processing units, CNL processing units, PHY processing units, and antennas according to FIG. 2 when the wireless communication apparatus 100 and the wireless communication apparatus 200 are described in distinction from one another like when the wireless communication apparatus 100 and the wireless communication apparatus 200 communicate, when the wireless communication apparatus 100 and the wireless communication apparatus 200 are not distinguished, these units are denoted by the CNL User processing unit 101, the CNL processing unit 102, the PHY processing unit 103, and the antenna 104 also for the wireless communication apparatus 200. FIG. 3 shows a procedure when the wireless communication apparatus 100 starts connection setting processing for establishing connection with the wireless communication apparatus 200, from the viewpoint of focusing on the CNL processing unit 102 of the wireless communication apparatus 100 and the CNL processing unit 202 of the wireless communication apparatus 200. In FIGS. 2 and 3, the wireless communication apparatus 100 is denoted by T/N and the wireless communication apparatus 200 is denoted by T.

In the example in FIG. 3, the wireless communication apparatus 100 makes a connection request to establish wireless connection with the wireless communication apparatus 200. The CNL User processing unit 101 of the wireless communication apparatus 100 outputs a start instruction of a connection setting to the CNL processing unit 102 as a control signal after receiving application data generated by an application operation at the wireless communication apparatus 100. Here, the control signal is called a primitive and the control signal related to the start instruction of a connection setting is called a CNL_CONNECT.request primitive. Though the configuration of a wireless communication apparatus may not be divided as shown in FIG. 1 in actual implementation, a control signal output from a processing unit that outputs a start instruction of a connection setting based on application data without being involved in the wireless system to a processing unit that handles the wireless system and related to the start instruction of a connection setting corresponds to the CNL_CONNECT.request primitive. For other primitive signals, substitutions like the above substitution are made in terms of implementation.

The CNL processing unit 102 accepts a CNL_CONNECT.request primitive from the CNL User processing unit 101 in a search state corresponding to a standby state. If a CNL_CONNECT.request primitive is received from the CNL User processing unit 101 in a search state, the CNL processing unit 102 transmits a connection request frame and makes a transition to a connection request state corresponding to a state to wait for a connection response frame from another wireless communication apparatus. In FIG. 3, the CNL_CONNECT.request primitive is denoted by CONNECT.req. Subsequently, the CNL processing unit 102 generates a connection request (also simply called C-Req) frame to be transmitted to another wireless communication apparatus and transmits the frame via the PHY processing unit 103 and the antenna 104. When a CNL_CONNECT.request primitive is received, the CNL processing unit 102 performs a step of connection processing based on the frame exchange with another wireless communication apparatus and an instruction (primitive) from the CNL User processing unit 101 to become an initiator.

At the PHY processing unit 103, a frame generated by the CNL processing unit 102 is converted into a PHY packet, modulation coded, converted into a signal of a predetermined frequency, and radiated into a wireless medium via the antenna 104. A wireless signal received via the antenna 104 is converted into a signal of the baseband frequency and further demodulated/decoded before being sent out to the CNL processing unit 102 by the PHY processing unit 103. When the wireless signal is correctly received by the wireless communication apparatus 100, the signal is recognized by the CNL processing unit 102 as a frame.

A CNL_CONNECT.request primitive contains no information about the wireless systems handled by the CNL processing unit 102 and PHY processing unit 103. Thus, the CNL processing unit 102 generates a C-Req frame to which information necessary to establish a wireless connection, that is, link control information related to a wireless link is added. A conventional wireless communication apparatus supporting only one wireless system does not need additional processing of link control information in the CNL processing unit (for example, the CNL processing unit 202 in FIG. 2). This is because the wireless system is uniquely determined and other wireless communication apparatuses receiving the C-Req frame implicitly know that the wireless system is used and thus, there is no need to make a notification.

The wireless communication apparatus 100 of the present embodiment supports, as described above, a plurality of wireless systems (for example, the wireless system 1 and the wireless system 2). Therefore, when a CNL_CONNECT.request primitive is received, the CNL processing unit 102 generates a C-Req frame to which link control information is added. The link control information is, more specifically, information indicating the support of a newly added wireless system to the conventional wireless system, that is, the wireless system 2.

The method of adding link control information to C-Req will be described.

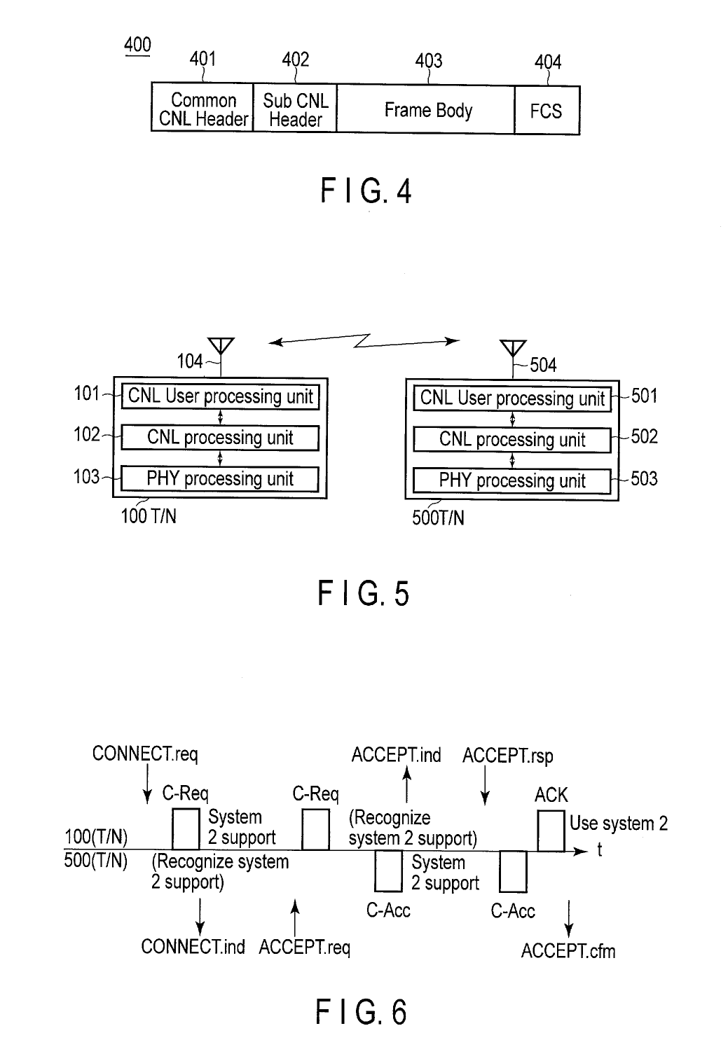

As an example, information indicating the support of the wireless system 2 is set in a field of a C-Req frame format where the field is undefined (i.e., reserved) in the wireless system 1. In other words, this means that an unused field in the wireless system 1 is re-defined as a field for notification of the wireless system in the wireless system 2. For example, as shown in FIG. 4, a TransferJet management frame 400 has a format including a common CNL header portion 401, a sub CNL header portion 402, a frame body portion 403, and an FCS (Frame Check Sequence) portion 404 which is used to determine whether the frame body portion 403 is correct on the side of a receiving wireless communication apparatus. The common CNL header portion 401 includes a transmission destination address field, a transmission source address field, a field indicating the number of frame bodies, and an HCS (Header Check Sequence) field which is used to determine whether the above information is correct on the side of a receiving wireless communication apparatus, and a 1-byte unused field remains. All or a portion of the 1-byte unused field may be used as a field for notification of other supported wireless systems. A field used by a combo apparatus to provide notification of other supported wireless systems will be called a wireless system notification field below. In this case, the wireless system notification field is naturally included in the fields which are subject of calculation by the HCS field in the common CNL header portion 401.

The sub CNL header portion 402 includes a field indicating whether it is necessary to transmit an ACK to a management frame, fields indicating the frame type (defined over two fields), a sequence number field, a field indicating the length of a frame body portion, and an HCS field to determine whether the above information is correct on the side of a receiving wireless communication apparatus, and a plurality of bits remain unused. All or a portion of the unused portion in the sub CNL header portion may be used as the wireless system notification field. Also in this case, the wireless system notification field is naturally included in the fields which are subject of calculation by the HCS field in the sub CNL header portion 402.

Further, in TransferJet, the frame body portion 403 of the management frame 400 is fixed to 32 bytes and a portion thereof remains unused. All or a portion of the unused portion may be used as the wireless system notification field.

Furthermore, when two wireless systems are distinguished like the example described here, 1 bit is sufficient for the wireless system notification field. On the other hand, when three or more wireless systems need to be distinguished, or there is a possibility that three or more wireless systems need to be distinguished in the future due to function extension, it is desirable to use a plurality of bits so that such wireless systems can be distinguished.

A field contained in the frame body portion of a management frame called LiCC (Link Control Command) Version handled in an embodiment described later will be described here. In TransferJet, which is defined by Standard ECMA-398, “1” (that is, “0x01”) is written into the 1-byte LiCC version field. In the present embodiment, it is assumed that both of the wireless system 1 and the wireless system 2 uses the same value “1” for the LiCC version.

In a CNL_CONNECT.request primitive, the parther wireless communication apparatus of a communication pair can also be specified. When, for example, the identifier (UID: Unique ID) of a wireless communication apparatus is included in a CNL_CONNECT.request primitive, the CNL processing unit 102 generates a C-Req frame in which the UID is specified as the transmission destination address. On the other hand, when no identifier of a specific wireless communication apparatus is specified or a broadcast transmission is explicitly specified as paging UID by a CNL_CONNECT.request primitive, the CNL processing unit 102 generates a C-Req frame in which paging UID as a broadcast address is set as the transmission destination address.

In FIG. 3, the CNL processing unit 202 of the wireless communication apparatus 200 receives a C-Req frame via the PHY processing unit 203 and the antenna 204 in a search state corresponding to a standby state. The CNL processing unit 202 recognizes the wireless system notification field in the received C-Req frame as an unused field and so does not check the content of the field. That is, the CNL processing unit 202 of the wireless communication apparatus 200 does not recognize that the support of the wireless system 2 by the wireless communication apparatus 100 is notified and ignores the notification content of the wireless system notification field. When the C-Req frame is received, the CNL processing unit 202 of the wireless communication apparatus 200 outputs a CNL_CONNECT.indication primitive to the CNL User processing unit 201 and makes a transition to an accept waiting state corresponding to a state waiting for an instruction from the CNL User processing unit 201 after receiving a connection request. In FIG. 3, CNL_CONNECT.indication is denoted by CONNECT.ind. By making a transition to the accept waiting state after receiving the C-Req frame, the CNL processing unit 202 performs a step of connection processing based on the frame exchange with the wireless communication apparatus 100 and an instruction (primitive) from the CNL User processing unit 201 to become a responder.

When the CNL_CONNECT.indication primitive is received, the CNL User processing unit 201 of the wireless communication apparatus 200 outputs, to the CNL processing unit 202, a CNL_ACCEPT.request primitive instructing the transmission of a connection accept (also simply called C-Acc) frame as a connection response frame to the wireless communication apparatus 100 that has transmitted the C-Req frame. In FIG. 3, the CNL_ACCEPT.request primitive is denoted by ACCEPT.req. When the CNL_ACCEPT.request primitive is received in the accept waiting state, the CNL processing unit 202 of the wireless communication apparatus 200 transmits a connection response frame (i.e., C-Acc frame) via the PHY processing unit 203 and the antenna 204 and makes a transition to a responder response state, in which reception of a response frame to the connection response frame is waited for.

The CNL_CONNECT.indication primitive may contain a UID of a wireless communication apparatus which is a transmission source of the C-Req frame so that the CNL User processing unit 201 can determine or indicate the wireless communication apparatus to which the C-Req frame should be transmitted when C-Req frames are also made acceptable after transiting to the accept waiting state and C-Req frames are received from a plurality of wireless communication apparatuses. In such a case, the CNL User processing unit 201 outputs a CNL_ACCEPT.request primitive containing a UID of a wireless communication apparatus which is a transmission destination of the C-Acc frame. For the CNL processing unit 202, there may be a plurality of wireless communication apparatuses as candidates of initiators during connection processing, more specifically, in the accept waiting state. Depending on the implementation, UID of, for example, the CNL_CONNECT.indication and CNL_ACCEPT.request primitives may be omitted. In such a case, the CNL processing unit 202 outputs, to the CNL User processing unit 201, a CNL_CONNECT.indication primitive in response to only the C-Req initially received and recognized. Based on the CNL_CONNECT.indication primitive, the CNL User processing unit 201 determines whether to transmit C-Acc. When the CNL User processing unit 201 determines to transmit C-Acc, the CNL User processing unit 201 outputs a CNL_ACCEPT.request primitive to the CNL processing unit 202. In this case, the wireless communication apparatus as a candidate to be connected is uniquely determined during connection processing by the CNL processing unit 202.

In FIG. 3, when a CNL_ACCEPT.request primitive is received in an accept waiting state, the CNL processing unit 202 of the wireless communication apparatus 200 generates a C-Acc frame. It is assumed here that according to the wireless system 2, the wireless system notification field is used in the C-Acc frame in the same manner as in the C-Req frame. An unused field in the wireless system 1 described above is common throughout the management frame and thus, it is desirable to use an unused field in the same place of the C-Acc frame as that of the C-Req frame as the wireless system notification field. The wireless communication apparatus 200 of the present embodiment does not support the wireless system 2 and so recognizes the wireless system notification field in the C-Acc field as an unused field. Typically, “0” is set to each bit of the unused field. In the present embodiment, the wireless communication apparatus 200 transmits the C-Acc frame with “0” in each bit of the field defined as the wireless system notification field in the wireless system 2.

The CNL processing unit 102 of the wireless communication apparatus 100 receives the C-Acc frame from the wireless communication apparatus 200 via the PHY processing unit 103. The CNL processing unit 102 accepts the C-Acc frame when the CNL processing unit 102 is in the connection request state. The CNL processing unit 102 having received the C-Acc frame recognizes that the wireless system notification field is not used or has the same bit setting with that of the unused field and thereby grasps the fact that the wireless communication apparatus 200 having transmitted the C-Acc frame does not support the wireless system 2. The result of judgment will be the same, even if the wireless system notification field is read on the side of the wireless communication apparatus 100 in such a way that “0” indicates that only the wireless system 1 is supported and “1” indicates that the wireless system 2 is also supported.

The CNL processing unit 102 of the wireless communication apparatus 100 correctly receives a C-Acc frame from the wireless communication apparatus 200 after transmitting a C-Req frame several times in the connection request state. The CNL processing unit 102 having received the C-Acc frame makes a transition to a response waiting state corresponding to a state waiting for an instruction after receiving a connection response from the CNL User processing unit 101 and outputs, to the CNL User processing unit 101, a CNL_ACCEPT.indication primitive providing notification of the reception of the connection response. In FIG. 3, the CNL_ACCEPT.indication primitive is denoted by ACCEPT.ind. If the CNL processing unit 102 is configured to allow a plurality of wireless communication apparatuses as candidates to be connected during connection processing, the CNL processing unit 102 accepts C-Acc frames also in the response waiting state and holds the identifier (UID) of the transmission source wireless communication apparatus of each C-Acc frame together with wireless systems supported by the wireless communication apparatus when making a transition from the connection request state to the response waiting state and after transiting to the response waiting state. In the example of FIG. 3, the CNL processing unit 102 holds information that the wireless communication apparatus 200 supports only the wireless system 1. For example, the CNL_ACCEPT.indication primitive may contain a UID of a wireless communication apparatus which is a transmission source of the C-Acc frame so that the CNL User processing unit 101 can determine or indicate the wireless communication apparatus to which the establishment of connection should be decided when the wireless communication apparatus 100 receives C-Acc frames from a plurality of wireless communication apparatuses. In a connection sequence of TransferJet, the decision of connection appears as an operation to transmit an ACK frame in response to a C-Acc frame from a wireless communication apparatus to which the connection is decided. In this case, the CNL processing unit 102 observes for a predetermined period in the response waiting state to check whether a C-Acc frame is received and outputs a CNL_ACCEPT.indication primitive to the CNL User processing unit 101 each time a C-Acc frame is received from a different wireless communication apparatus. The CNL User processing unit 101 accepts the CNL_ACCEPT.indication primitive for a predetermined period. The CNL User processing unit 101 decides the connection to one wireless communication apparatus among wireless communication apparatuses of transmission sources of C-Acc and specifies the UID of the decided wireless communication apparatus in the CNL_ACCEPT.response primitive. In FIG. 3, the CNL_ACCEPT.response primitive is denoted by ACCEPT.rsp. If the connection establishment is not permitted even though a CNL_ACCEPT.indication primitive is accepted by the CNL User processing unit 101, a CNL_RELEASE.request primitive is output to the CNL processing unit 102 and upon receipt of the primitive, the CNL processing unit 102 generates a connection release (also simply called C-Rls) frame which is a management frame of connection release and transmits the frame via the PHY processing unit 103 before making a transition to a search state. When the CNL processing unit 102 is configured to allow a plurality of wireless communication apparatuses as connection candidates, the CNL User processing unit 101 outputs a CNL_RELEASE.request primitive if none of wireless communication apparatuses notified by a plurality of input CNL_ACCEPT.indication primitives is permitted to establish connection. In this case, the CNL User processing unit 101 desirably holds a timer to accept a CNL_ACCEPT.indication primitive for a fixed period to determine whether to permit the establishment of connection when the time exceeds the fixed period. When the CNL processing unit 102 limits the number of connection candidates to, as will be described below, one apparatus, the CNL User processing unit 101 outputs a CNL_RELEASE.request primitive to a wireless communication apparatus notified by the CNL_ACCEPT.indication primitive when the establishment of connection is not permitted.

When a CNL_ACCEPT.response primitive is received from the CNL User processing unit 101, the CNL processing unit 102 makes a transition to a connected state corresponding to the final state of connection processing as an initiator. More specifically, the connected state is distinguished between an initiator and a responder in TransferJet and in the example of FIG. 3, the CNL processing unit 102 of the wireless communication apparatus 100 makes a transition to the initiator connected state. If a C-Acc in which the same UID as that specified in the C-Req frame is written in the transmission source address is received in the connected state, the CNL processing unit 102 of the wireless communication apparatus 100 transmits an ACK frame in response to the C-Acc frame. The wireless communication apparatus 100 thereby completes connection settings to the specified wireless communication apparatus (in this example, the wireless communication apparatus 200).

When a CNL_ACCEPT.reponse primitive is received in the response waiting state, if the CNL processing unit 102 holds information about wireless communication apparatuses which are transmission source of held C-Acc frames (pairs of an identifier (UID) and corresponding supported wireless systems), it is desirable to discard information about any wireless communication apparatus other than the wireless communication apparatus specified by the UID in the primitive. By discarding unnecessary information in this manner when appropriate, the load on the memory can be reduced. The CNL processing unit 102 of the wireless communication apparatus 100 as described above is configured to allow a plurality of wireless communication apparatuses as candidates to be connected during connection processing, more specifically, in the response waiting state. On the other hand, depending on the implementation, for example, the UID in the CNL_ACCEPT.indication and CNL_ACCEPT.response primitives may be omitted by the CNL processing unit 102 outputing a CNL_ACCEPT.indication primitive to the CNL User processing unit 101 based on only the C-Acc frame initially received and recognized during the connection processing, and the CNL User processing unit 101 may determine whether to decide the connection based on the CNL_ACCEPT.indication primitive so that if the connection is decided, the CNL User processing unit 101 outputs a CNL_ACCEPT.response primitive to the CNL processing unit 102. In this case, the CNL processing unit 102 is configured to limit the number of wireless communication apparatuses as candidates to be connected to one. Then, the CNL processing unit 102 holds a pair of the identifier and supported wireless systems of the wireless communication apparatus which is the transmission source of the C-Acc frame initially received and recognized (here, the wireless communication apparatus 200). When the CNL_ACCEPT.response primitive is received, the CNL processing unit 102 makes a transition to the connected state and transmits an ACK frame in which the identifier of the held wireless communication apparatus (here, the wireless communication apparatus 200) is written as the transmission destination address. In the example of FIG. 3, the wireless communication apparatus 100 receives the C-Acc frame from the wireless communication apparatus 200 only and thus, the result is the same regardless of whether the wireless communication apparatus 100 is configured to allow a plurality of target wireless communication apparatuses during connection processing or configured to limit the number of target wireless communication apparatuses to one, and the connection to the wireless communication apparatus 200 is completed and data frames can be exchanged with the wireless communication apparatus 200 by using the wireless system 1. Here, the transmission destination address of the ACK frame is the wireless communication apparatus 200 and the transmission source address thereof is the wireless communication apparatus 100.

In the wireless system 1 of the present embodiment, as described above, variations of a plurality of data rates are permitted. Thus, before transmitting a data frame to the wireless communication apparatus 200, the CNL processing unit 102 of the wireless communication apparatus 100 determines which data rate of the wireless system 1 to use and gives instructions to the PHY processing unit 103 about the data rate to be used when a transmission request of the data frame is output to the PHY processing unit 103. As will be described below, this also applies when a data frame is transmitted to the wireless communication apparatus 100 after it becomes possible for the CNL processing unit 202 of the wireless communication apparatus 200 to exchange data frames with the wireless communication apparatus 100.

In each of the wireless communication apparatuses, 100 and 200, when a data frame received from the CNL processing unit 102 is converted into a PHY packet, the PHY processing unit 103 makes a notification of the data rate specified in the field of the header portion of the PHY packet (more specifically, the rate field in the PHY Header field) and transmits a payload portion (a data frame received from the CNL processing unit 102 is placed here) at the specified data rate (more specifically, transmitted after performing spreading, scrambling, and modulation). Regarding a portion such as a PHY header portion that needs to be received and read even in a state in which the selected data rate cannot be grasped, the data rate for each wireless system is uniquely determined like, for example, the minimum data rate of each wireless system.

The wireless communication apparatus 200 correctly receives an ACK frame in response to a C-Acc frame from the wireless communication apparatus 100 after transmitting the C-Acc frame several times. When the ACK frame to the C-Acc frame is received, the CNL processing unit 202 of the wireless communication apparatus 200 outputs a CNL_ACCEPT.confirm primitive providing notification of the establishment of connection to the CNL User processing unit 201. In FIG. 3, the CNL_ACCEPT.confirm primitive is denoted by ACCEPT.cfm. Subsequently, the CNL processing unit 202 of the wireless communication apparatus 200 makes a transition from the responder response state to the connected state corresponding to the final state of the connection processing. More specifically, the connected state is distinguished between an initiator and a responder in TransferJet and in the example of FIG. 3, the CNL processing unit 202 of the wireless communication apparatus 200 makes a transition to a responder connected state. Accordingly, the wireless communication apparatus 200 completes connection settings to the wireless communication apparatus 100. Subsequently, the wireless communication apparatus 100 exchanges data frames with the wireless communication apparatus 200 by implicitly using the wireless system 1.

Next, as shown in FIG. 5, a case will be described where combo apparatuses, 100 and 500, supporting both of the wireless system 1 in the first generation and the wireless system 2 in the second generation perform communication. The wireless communication apparatus 500 shown in FIG. 5 is configured in the same manner as the wireless communication apparatus 100 shown in FIG. 1. More specifically, the wireless communication apparatus 500 includes a CNL User processing unit 501, a CNL processing unit 502, a PHY processing unit 503, and an antenna 504, and the CNL User processing unit 501, the CNL processing unit 502, the PHY processing unit 503, and the antenna 504 operate in the same manner as the CNL User processing unit 101, the CNL processing unit 102, the PHY processing unit 103, and the antenna 104, respectively. While different reference numbers are attached to the CNL User processing units, CNL processing units, PHY processing units, and antennas according to FIG. 5 when the wireless communication apparatus 100 and the wireless communication apparatus 500 are described by distinguishing these apparatuses like when the wireless communication apparatus 100 and the wireless communication apparatus 500 communicate, when the wireless communication apparatus 100 and the wireless communication apparatus 500 are not distinguished, these units are denoted by the CNL User processing unit 101, the CNL processing unit 102, the PHY processing unit 103, and the antenna 104 also for the wireless communication apparatus 500. FIG. 6 shows a procedure for establishing connection to the wireless communication apparatus 500 after the wireless communication apparatus 100 starts connection setting processing from the viewpoint of focusing on the CNL processing unit 102 of the wireless communication apparatus 100 and the CNL processing unit 502 of the wireless communication apparatus 500. In FIGS. 5 and 6, the wireless communication apparatuses, 100 and 500, are both denoted by T/N.

In FIG. 6, the processing in which the wireless communication apparatus 100 transmits a C-Req frame is the same as that described with reference to FIG. 3 and thus, the description thereof is omitted.

The wireless communication apparatus 500 receives a C-Req frame from the wireless communication apparatus 100. The CNL processing unit 502 of the wireless communication apparatus 500 performs reception processing of the C-Req frame when the state of the connection processing procedure is the search state. The wireless communication apparatus 500 supports the wireless system 2 as well and thus, when a C-Req frame is received in the search state, the CNL processing unit 502 of the wireless communication apparatus 500 recognizes the use of the wireless system notification field and grasps that the wireless communication apparatus 100 supports the wireless system 2. That is, the CNL processing unit 502 of the wireless communication apparatus 500 extracts information indicating that the wireless communication apparatus 100 of the transmission source supports the wireless system 2 from the received C-Req frame and holds the information. If the CNL processing unit 502 is configured to allow a plurality of wireless communication apparatuses as candidates to be connected, the CNL processing unit 502 holds the identifier of the wireless communication apparatus 100 together with the information indicating that the wireless communication apparatus 100 supports the wireless system 2.

Subsequently, the CNL processing unit 502 of the wireless communication apparatus 500 outputs a CNL_CONNECT.indication primitive to the CNL User processing unit 501 and makes a transition to the accept waiting state. If the wireless communication apparatus 500 is configured to allow a plurality of wireless communication apparatuses as candidates to be connected, the CNL processing unit 502 accepts a C-Req frame even after making a transition to the accept waiting state and each time a C-Req frame is received, the CNL processing unit 502 outputs a CNL_CONNECT.indication primitive to the CNL User processing unit 501. Additionally, the CNL processing unit 502 may filter the C-Req frames received and output a CNL_CONNECT.indication primitive when the C-Req frame is from a different wireless communication apparatus. The CNL User processing unit 501 accepts the CNL_CONNECT.indication primitive for a predetermined period and then decides a wireless communication apparatus to be connected from among the wireless communication apparatuses which are transmission sources of C-Req frames. The CNL User processing unit 501 notifies the CNL processing unit 502 of the decided wireless communication apparatus as a communication partner through the CNL_ACCEPT.request primitive.

When the CNL processing unit 502 of the wireless communication apparatus 500 is in the accept waiting state, the CNL processing unit 502 accepts input of the CNL_ACCEPT.request primitive from the CNL User processing unit 501. When the CNL processing unit 502 receives the CNL_ACCEPT.request primitive from the CNL User processing unit 501 in the accept waiting state, the CNL processing unit 502 makes a transition to the responder response state. At this point, if the CNL processing unit 502 holds information about held wireless communication apparatuses (pairs of an identifier and corresponding supported wireless systems), it is desirable to discard information about any wireless communication apparatus other than the wireless communication apparatus specified by the UID in the CNL_ACCEPT.request primitive. By discarding unnecessary information in this manner when appropriate, the load on the memory can be reduced.

The CNL processing unit 502 of the wireless communication apparatus 500 confirms the identifier specified by the CNL_ACCEPT.request primitive. If the identifier is that of the wireless communication apparatus 100, the CNL processing unit 502 generates a C-Acc frame of which the transmission destination address is the wireless communication apparatus 100 and the support of the wireless system 2 is written in the wireless system notification field and transmits the C-Acc frame via the PHY processing unit 503.

If the CNL processing unit 502 of the wireless communication apparatus 500 is configured to hold a single wireless communication apparatus as a candidate to be connected, the CNL processing unit 502 holds the identifier of the wireless communication apparatus (here, the wireless communication apparatus 100) which is the transmission source of the received C-Req frame and the supported wireless systems of the wireless communication apparatus (here, information indicating the support of the wireless system 2). Subsequently, the CNL processing unit 502 outputs a CNL_CONNECT.indication primitive and makes a transition to the accept waiting state. In this case, the CNL processing unit 502 in the accept waiting state no longer accepts a C-Req frame. When a CNL_ACCEPT.request primitive is received from the CNL User processing unit 501, the CNL processing unit 502 generates a C-Acc frame of which the transmission destination address is the wireless communication apparatus 100 (because the wireless communication apparatus 100 is implicitly regarded as the candidate to be connected) and the support of the wireless system 2 is written in the wireless system notification field and transmits the C-Acc frame via the PHY processing unit 503.

The wireless communication apparatus 100 receives the C-Acc frame from the wireless communication apparatus 500. The CNL processing unit 102 of the wireless communication apparatus 100 receives the C-Acc frame in the connection request state. The CNL processing unit 102 extracts wireless system information indicating that the wireless communication apparatus 500 supports the wireless system 2 from the C-Acc frame and grasps that the wireless communication apparatus 500 supports the wireless system 2 based on the C-Acc frame. The CNL processing unit 102 holds the identifier of the wireless communication apparatus 500 together with information indicating a wireless system supported by the wireless communication apparatus 500 (here, information indicating that the wireless system 2 is supported).

If the CNL processing unit 102 of the wireless communication apparatus 100 is configured to allow a plurality of wireless communication apparatuses as candidates to be connected, the CNL processing unit 102 holds the identifiers of wireless communication apparatuses via association with their supported wireless systems. The CNL processing unit 102 outputs a CNL_ACCEPT.indication primitive to the CNL User processing unit 101 and makes a transition to the response waiting state. When a CNL_ACCEPT.response primitive is received from the CNL User processing unit 101 in the response waiting state, the CNL processing unit 102 makes a transition to the initiator connected state and as described above, transmits an ACK frame in response to the C-Acc frame from the target wireless communication apparatus. The wireless communication apparatus 100 establishes connection to the target wireless communication apparatus (here, the wireless communication apparatus 500) and can exchange data by using the wireless system 2. Here, as the wireless system 1 is also common to the wireless communication apparatus 100 and the wireless communication apparatus 500, the wireless system 1 can be also used.

The CNL processing unit 502 of the wireless communication apparatus 500 receives an ACK frame to the transmitted C-Acc frame in the responder response state and, if it is verified that the ACK frame has come from the target wireless communication apparatus (here, the wireless communication apparatus 100), recognizes the establishment of connection to the target wireless communication apparatus (here, the wireless communication apparatus 100). Subsequently, the CNL processing unit 502 outputs a CNL_ACCEPT.confirm primitive to the CNL User processing unit 501 and makes a transition to the responder connected state. Data can now be exchanged between the wireless communication apparatuses 100 and 500 by using the wireless system supported by the apparatuses 100 and 500 (here, the wireless system 2 in addition to the wireless system 1).

Next, another example of the method of providing notification of supported wireless systems will be described.

In the example of FIG. 6, the use of the wireless system 2 is mutually confirmed between the wireless communication apparatus 100 and the wireless communication apparatus 500 by exchanging two management frames in which the wireless communication apparatus 100 notifies support of the wireless system 2 via C-Req and the wireless communication apparatus 500 notifies support of the wireless system 2 via C-Acc. This is a method based on a policy that if a wireless communication apparatus notifies that a newer generation wireless system is supported and the wireless communication apparatus on the other side notifies that the newer generation wireless system is supported, the newer generation wireless system will always be made available. In such a case, however, there is no need to always make the newer wireless system available. For example, the wireless communication apparatus 100 may be allowed to decide whether to use the wireless system 2 after the wireless communication apparatus 100 notifies that the wireless system 2 is supported via a C-Req frame and the wireless communication apparatus 500 requests the support of the wireless system 2. Furthermore, even if the wireless communication apparatus 100 supports the wireless system 2, there is no need for the wireless communication apparatus 500 to always request and provide notification of the support of the wireless system 2. For example, in view of power consumption and remaining battery life or power supply conditions, or from receiving conditions such as received power or error vector magnitude (EVM) of a C-Req frame from the wireless communication apparatus 100 and from reasons that more robust communication can be expected by the wireless system 1, the wireless system 1 may be requested. Conversely, also on the side of the wireless communication apparatus 100, for example, from receiving conditions such as received power or EVM of a C-Req frame from the wireless communication apparatus 500 and from reasons that more robust communication can be expected by the wireless system 1, the wireless system to be used may be limited to the wireless system 1. In this case, the wireless system to be used is determined through exchanging three management frames. To be concrete, the finally determined wireless system can be notified by an ACK frame in the previous frame exchange sequence by preparing the wireless system notification field in the ACK frame, for example.

In the present embodiment, C-Req, C-Acc, and ACK as frames to be transmitted in the connection setting processing are transmitted by the wireless system 1. Accordingly, the wireless communication apparatus 100 supporting both of the wireless system 1 and the wireless system 2 can establish connection to both the wireless communication apparatus 200 supporting only the wireless system 1 and the wireless communication apparatus 500 supporting both of the wireless system 1 and the wireless system 2. In this manner, backward compatibility can be guaranteed for the wireless system 1 and a wireless communication apparatus supporting only the wireless system 1.

Next, a case will be described where the wireless communication apparatus 200 supporting only the wireless system 1 makes a connection request to establish wireless connection to the wireless communication apparatus 100 supporting both of the wireless system 1 and the wireless system 2.

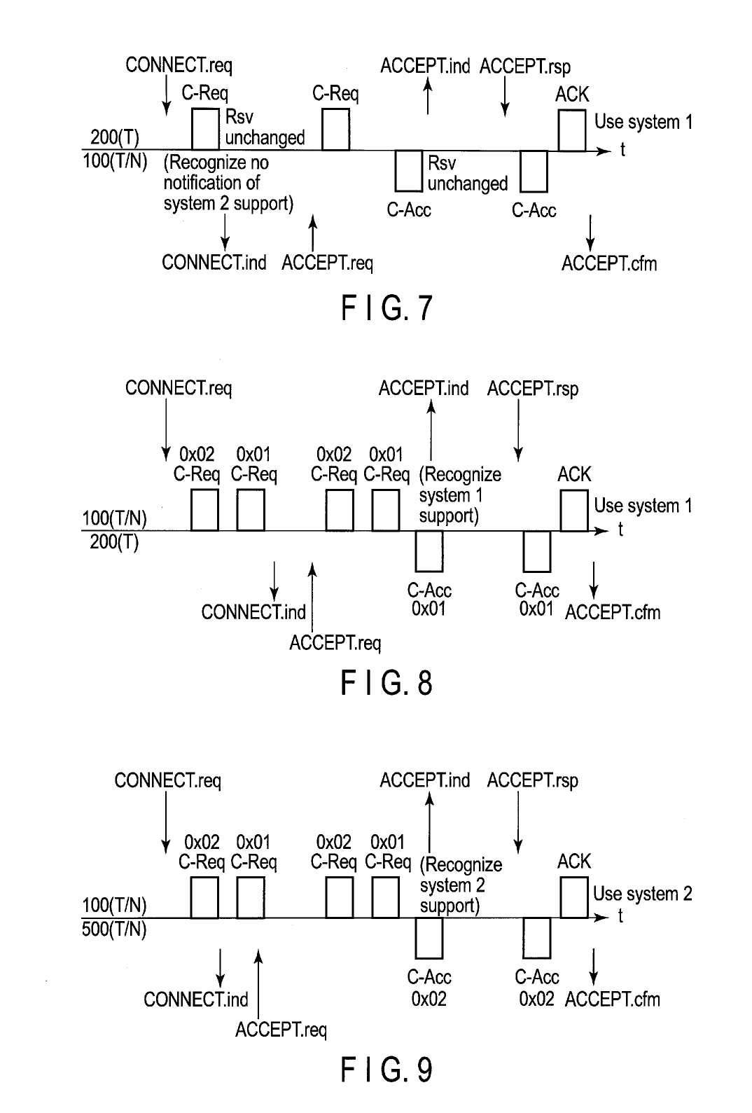

FIG. 7 shows a procedure for establishing connection to the wireless communication apparatus 100 after the wireless communication apparatus 200 starts connection setting processing from the viewpoint of focusing on the CNL processing unit 202 of the wireless communication apparatus 200 and the CNL processing unit 102 of the wireless communication apparatus 100. When the wireless communication apparatus 200 makes a connection request, a CNL_CONNECT.request primitive is provided from the CNL User processing unit 201 to the CNL processing unit 202 in the wireless communication apparatus 200. In FIG. 7, the CNL_CONNECT.request primitive is denoted by CONNECT.req. When the CNL_CONNECT.request primitive is received in the search state, the CNL processing unit 202 of the wireless communication apparatus 200 generates C-Req as a connection request frame in the same manner as the processing by the CNL processing unit 102 of the wireless communication apparatus 100 described with reference to FIGS. 3 and 6 and transmits the C-Req frame via the PHY processing unit 203. However, in the C-Req frame generated by the CNL processing unit 202 of the wireless communication apparatus 200, the field used as the wireless system notification field in the wireless system 2 described above is unused. That is, the CNL processing unit 202 of the wireless communication apparatus 200 writes “0” to each bit of this field. This is because the wireless communication apparatus 200 does not support the wireless system 2 and so does not recognize that the field is used and is defined for the wireless system 2. Therefore, the wireless communication apparatus 200 transmits C-Req that does not contain information about wireless systems supported by the wireless communication apparatus 200.

The CNL processing unit 102 of the wireless communication apparatus 100 receives the C-Req frame from the wireless communication apparatus 200 via the PHY processing unit 103. The CNL processing unit 102 recognizes that the field defined as the wireless system notification field in the wireless system 2 is “0” in the received C-Req frame and grasps that the wireless communication apparatus 200 that has transmitted the C-Req frame does not support the wireless system 2. Therefore, the CNL processing unit 102 holds information that the wireless communication apparatus 200 supports only the wireless system 1. Whether the CNL processing unit 102 holds a plurality of pairs of an identifier of the wireless communication apparatus and corresponding supported wireless systems depends on, as described above, whether the CNL processing unit 102 is configured to allow a plurality of wireless communication apparatuses as candidates to be connected during connection processing.

When a C-Req frame is received in the search state, the CNL processing unit 102 of the wireless communication apparatus 100 outputs a CNL_CONNECT.indication primitive to the CNL User processing unit 101 in response to the received C-Req frame and makes a transition to the accept waiting state. In FIG. 7, the CNL_CONNECT.indication primitive is denoted by CONNECT.ind. After receiving the CNL_CONNECT.indication primitive, the CNL User processing unit 101 outputs a CNL_ACCEPT.request primitive to the CNL processing unit 102. In FIG. 7, the CNL_ACCEPT.request primitive is denoted by ACCEPT.req. When the CNL_ACCEPT.request primitive is received from the CNL User processing unit 101 in the accept waiting state, the CNL processing unit 102 makes a transition to the responder response state and generates a C-Acc frame to transmit the C-Acc frame via the PHY processing unit 103. When generating the C-Acc frame, the CNL processing unit 102 writes “0” to the field defined as the wireless system notification field in the wireless system 2. That is, the CNL processing unit 102 generates a C-Acc frame with the field defined as the wireless system notification field in the wireless system 2 the same as being unused. If the connection establishment is not permitted even if a CNL_CONNECT.indication primitive is received by the CNL User processing unit 101, a CNL_RELEASE.request primitive is output to the CNL processing unit 102 and upon receipt of the primitive, the CNL processing unit 102 generates a C-Rls frame and transmits the frame via the PHY processing unit 103 before making a transition to the search state. When the CNL processing unit 102 is configured to allow a plurality of wireless communication apparatuses as connection candidates, the CNL User processing unit 101 outputs a CNL_RELEASE.request primitive if none of wireless communication apparatuses notified by a plurality of input CNL_CONNECT.indication primitives is permitted to establish connection. In this case, the CNL User processing unit 101 desirably holds a timer to accept a CNL_CONNECT.indication primitive for a fixed period to determine whether to permit the establishment of connection when the time exceeds the fixed period. When the CNL processing unit 102 limits the number of connection candidates to one apparatus, the CNL User processing unit 101 outputs a CNL_RELEASE.request primitive when the establishment of connection to the wireless communication apparatus notified by the CNL_CONNECT.indication primitive is not permitted.

The wireless communication apparatus 200 receives a C-Acc frame from the wireless communication apparatus 100. The CNL processing unit 202 of the wireless communication apparatus 200 accepts the C-Acc frame in the connection request state, outputs a CNL_ACCEPT.indication primitive to the CNL User processing unit 201, and makes a transition to the response waiting state. In FIG. 7, the CNL_ACCEPT.indication primitive is denoted by ACCEPT.ind. Subsequently, when a CNL_ACCEPT.response primitive is received from the CNL User processing unit 201 in the response waiting state, the CNL processing unit 202 of the wireless communication apparatus 200 makes a transition to the initiator connected state and transmits an ACK frame in response to C-Req from the target wireless communication apparatus (here, the wireless communication apparatus 100). In FIG. 7, the CNL_ACCEPT.response primitive is denoted by ACCEPT.rsp. When the wireless communication apparatus is specified by a primitive using an identifier, the target wireless communication apparatus is the wireless communication apparatus of the specified identifier and when the wireless communication apparatus is not specified by a primitive, the target wireless communication apparatus is the wireless communication apparatus held by the CNL processing unit 202 when C-Req is received.

When the ACK frame in response to the C-Acc frame transmitted by the apparatus 100 in the responder response state is detected, the CNL processing unit 102 of the wireless communication apparatus 100 outputs a CNL_ACCEPT.confirm primitive to the CNL User processing unit 101 and makes a transition to the responder response state.

When the connection setting processing is completed in this manner, the wireless communication apparatus 100 and the wireless communication apparatus 200 start to exchange data in the wireless system 1. Furthermore, processing of a received frame and primitive input from the CNL User processing unit 101 in each wireless communication apparatus are limited by, as described above, which state the CNL processing unit 102 is in.

In a wireless communication apparatus according to the present embodiment, as described above, a control signal passed from the CNL User processing unit 101 to the CNL processing unit 102 is the same as the conventional control signal, that is, an interface signal between the CNL User processing unit 101 and the CNL processing unit 102 is the same as the conventional interface signal and the CNL processing unit 102 selects an appropriate wireless system used for communication (data exchange) with the wireless communication apparatus of the communication pair from a plurality of wireless systems.

In a wireless communication apparatus (for example, the wireless communication apparatus 100 and the wireless communication apparatus 500) supporting a plurality of wireless systems, the CNL processing unit 102 includes a function to use a plurality of different wireless systems properly. More specifically, the CNL processing unit 102 shown in FIG. 1 contains an entity to manage CNL, that is, CLME (Connection Layer Management Entity).

In a wireless communication apparatus according to the first embodiment, as described above, when a connection request is made, the CNL processing unit 102 generates and transmits a connection request frame corresponding to a plurality of wireless systems (for example, the wireless system 1 and the wireless system 2). This makes it possible to establish connection to another wireless communication apparatus supporting at least one of these wireless systems. More specifically, a frame related to connection corresponding to the wireless system 2 is based on a frame related to connection corresponding to the wireless system 1. Thus, demodulation and decoding can be performed on the frame related to connection corresponding to the wireless system 2 in a wireless communication apparatus supporting only the wireless system 1, a wireless communication apparatus supporting only the wireless system 2, and also a wireless communication apparatus supporting both the wireless system 1 and the wireless system 2. As a result, the wireless system 2 can guarantee backward compatibility with the wireless system 1. By adopting a frame related to connection corresponding to the wireless system 2 based on a frame related to connection corresponding to the wireless system 1, there is no need to increase the number of frame types.

Further, the CNL processing unit 102 receives a connection response frame in response to the connection request frame from another wireless communication apparatus and grasps a wireless system (or wireless system) supported by the other wireless communication apparatus based on the received connection response frame. Accordingly, the CNL processing unit 102 can determine the wireless system used for data exchange with the other wireless communication apparatus. When a connection request is received, the CNL processing unit 102 grasps wireless systems supported by another wireless communication apparatus based on the connection request frame from the other wireless communication apparatus. Accordingly, the CNL processing unit 102 can determine the wireless system used for data exchange with the other wireless communication apparatus.

### Second Embodiment

In the first embodiment, supported wireless systems are notified via a CNL frame. In the second embodiment, by contrast, notification of supported wireless systems is set in a PHY packet when a C-Req frame is converted into the PHY packet by a PHY processing unit 103.

In TransferJet, for example, a Rate field is provided in a PHY header portion of the PHY packet. The Rate field is a portion that indicates the transmission rate of a payload portion of the PHY packet. In TransferJet conforming to ECMA-398 (hereinafter, called the current TransferJet for convenience sake), a 4-bit rate field is provided while the number of transmission rates of the payload portion is five. Thus, the Rate field has a reserved portion. More specifically, five rates of “0x1” to “0x5” are allocated to the rate field to indicate the transmission rate of the payload portion of the current TransferJet and “0x0” and “0x6” to “0xF” are undefined. The defined transmission rates are those supported by the wireless system 1. If, as described in the first embodiment, N T-Jet is assumed as a wireless system 2, a plurality of transmission rates can newly be defined for N T-Jet. However, to enable the CNL processing unit of a wireless communication apparatus that does not support the wireless system 2 and supports only a wireless system 1 like in the first embodiment (for example, the CNL processing unit 202 in FIG. 2) to perform reception processing of a frame to respond to the frame, the transmission rate of the payload portion of an actual PHY packet needs to be selected from transmission rates of the wireless system 1 while notifying that the wireless system 2 is supported. In a method of notifying that the wireless system 2 is supported by using a reserved portion of the Rate field, the PHY processing unit (for example, the PHY processing unit 203 in FIG. 2) of a wireless communication apparatus supporting only the wireless system 1 recognizes that an unsupported transmission rate is specified and does not perform processing of extracting the payload portion by performing demodulation and decoding. Therefore, it is inappropriate to provide notification of supported wireless systems by using reserved portions in the Rate field of the former system (ex. current TransferJet).

In the present embodiment, a reserved field provided in the PHY header portion separately from the Rate field is used. The PHY header portion of the current TransferJet has an 8-bit reserved field. When, for example, two wireless systems are to be identified, 1 bit of the reserved field can be newly defined as a wireless system notification field. When, as described in the first embodiment, three or more wireless systems need to be identified or a future extension is expected, a plurality of bits may be defined as a wireless system notification field. In the second embodiment, the reserved field of the PHY header portion is used in the same manner as when the reserved field in a management frame is used at the CNL level as described in the first embodiment. The PHY processing unit (for example, the PHY processing unit 203 in FIG. 2) of a wireless communication apparatus supporting only the wireless system 1 is required not to check the field as undefined (that is, not to determine to stop extraction processing of the payload portion because “0” is not set). Similar requirement conditions apply when a notification is made at the management frame level of a CNL processing unit 102 in the first embodiment.

In the present embodiment, the wireless system is notified at the PHY level, but the wireless system 1 and the wireless system 2 are identified and selected properly still at the CNL level. Therefore, a wireless communication apparatus according to the present embodiment capable of supporting the wireless system notification field at the PHY level needs a mechanism to provide notification of wireless systems supported by another wireless communication apparatus from the PHY processing unit 103 to the CNL processing unit 102 and a mechanism to provide notification of wireless systems supported by this wireless communication apparatus from the CNL processing unit 102 to the PHY processing unit 103.

For example, the procedure for selecting the wireless system 1 as the wireless system in a connection process of a wireless communication apparatus 100 supporting both the wireless system 1 and the wireless system 2 and a wireless communication apparatus 200 supporting only the wireless system 2 is basically the same as that described in the first embodiment. In the wireless communication apparatus 100 according to the present embodiment, however, the CNL processing unit 102 instructs the PHY processing unit 103 to provide notification of wireless systems instead of providing notification of supported wireless systems via a frame on CNL and the CNL processing unit 102 receives notification from the PHY processing unit 103 to recognize wireless systems supported by the peer wireless communication apparatus instead of recognizing wireless systems supported by the peer wireless communication apparatus via a frame on CNL. For example, in FIG. 3, the CNL processing unit 102 of the wireless communication apparatus 100 generates a C-Req frame and passes the C-Req frame to the PHY processing unit 103 to instruct the transmission thereof and also at the same time, instructs the PHY processing unit 103 to include notification of the support of the wireless system 2. When the PHY processing unit 103 generates a PHY packet, the PHY processing unit 103 enters information indicating the support of the wireless system 2 in the PHY header and also enters a C-Req frame received from the CNL processing unit 102 in the payload portion thereof.

In the wireless communication apparatus 200, on the other hand, when reception processing of a PHY packet is performed, the PHY processing unit 203 does not grasp the presence of notification of the support of the wireless system 2 and so does not notify the CNL processing unit 202 of information thereof. In other words, such an interface signal is not prepared. Thus, the CNL processing unit 202 of the wireless communication apparatus 200 does not grasp the notification of wireless systems and performs processing by assuming that the wireless communication apparatus 100 only supports the wireless system 1. Thus, when the wireless communication apparatus 200 transmits a C-Acc frame, the PHY header portion of the PHY packet thereof does not contain any notification of wireless systems and the PHY processing unit 103 of the wireless communication apparatus 100 does not extract information indicating the support of the wireless system 2 when the PHY packet is received and therefore, information of the support of the wireless system 2 is not provided when the received C-Acc frame is passed to the CNL processing unit 102. Therefore, the CNL processing unit 102 of the wireless communication apparatus 100 grasps that the wireless communication apparatus 200 that has transmitted the C-Acc frame does not support the wireless system 2, that is, supports only the wireless system 1. Then, the wireless communication apparatus 100 decides to use the wireless system 1 to exchange data frames when a decision is made to connect to the wireless communication apparatus 200. Then, when a data frame is transmitted from the wireless communication apparatus 100 to the wireless communication apparatus 200, there is no need to make a notification of the support of the wireless system 2 and thus, the CNL processing unit 102 does not have to instruct the PHY processing unit 103 to enter notification of the support of the wireless system 2 in the PHY packet. Therefore, in a PHY packet of a data frame exchanged between the wireless communication apparatus 100 and the wireless communication apparatus 200, a field area used in a PHY packet for connection processing for notification of a wireless system may be brought back to a reserved field.

The procedure for selecting the wireless system 2 as the wireless system in a connection process of the wireless communication apparatus 100 and a wireless communication apparatus 500 supporting both the wireless system 1 and the wireless system 2 is basically understood by referring to the example in FIG. 6 in the first embodiment and the example of connection between the wireless communication apparatus 100 and the wireless communication apparatus 200 in the present embodiment. In this case, the wireless communication apparatus 500 supports the wireless system 2 as well and thus, when a PHY packet carrying a C-Req frame is received by the PHY processing unit 503, the notification of the support of the wireless system 2 in the PHY packet is grasped and when the payload portion (corresponding to the C-Req frame) in the PHY packet is passed to the CNL processing unit 502, the support of the wireless system 2 by the wireless communication apparatus 100 is also notified. Therefore, the CNL processing unit 502 of the wireless communication apparatus 500 can grasp that the wireless communication apparatus 100 that has transmitted the C-Req frame supports the wireless system 2. When the CNL processing unit 502 is instructed to connect to the wireless communication apparatus 100 via a CNL_ACCEPT.request primitive from the CNL User processing unit 501, the CNL processing unit 502 generates a C-Acc frame. The CNL processing unit 502 passes the C-Acc frame to the PHY processing unit 503 to instruct the transmission thereof and also at the same time, instructs the PHY processing unit 503 to notify that the wireless system 2 is supported. The PHY processing unit 503 generates a PHY packet including a C-Acc frame in the payload portion while inserting a notification that the wireless system 2 is supported in the PHY header, and transmits the PHY packet. The wireless communication apparatus 100 grasps that the wireless communication apparatus 500 of the transmission source of the received C-Acc frame supports the wireless system 2 in a process similar to that when the wireless communication apparatus 500 receives a C-Req frame. In this case, the wireless system 2 is used for exchanging data frames. In data frames transmitted from both the wireless communication apparatus 100 and the wireless communication apparatus 500, a transmission rate of the wireless system 2 used for each of the PHY payloads is set in the Rate field of the PHY header portion in a PHY packet. That is, the transmission rates used in the wireless system 2 are allocated to each one of the values in the Rate field, where the values are undefined when only the wireless system 1 is supported. If a plurality of transmission rates are used in the wireless system 2, these transmission rates are allocated to each of a plurality of values undefined in the Rate field for the wireless system 1. Also in this case, a re-notification of the support of the wireless system 2 may be made via the PHY header portion of a PHY packet or the field may be brought back to an reserved field in a PHY packet of a data frame, like when connection is established by the wireless system 1.

When the wireless communication apparatus 200 makes a connection request to establish wireless connection to the wireless communication apparatus 100, the example of FIG. 7 in the first embodiment may be referred to under the assumption that there is no interface signal related to the notification of wireless systems between the PHY processing unit 203 and the CNL processing unit 202 of the wireless communication apparatus 200.

In a wireless communication apparatus according to the second embodiment, as described above, the CNL processing unit 102 instructs the PHY processing unit 103 to transmit a connection request frame with notification of wireless systems that can be supported by this apparatus in a PHY packet containing the PHY header portion. The PHY processing unit 103 extracts information indicating wireless systems supported by another wireless communication apparatus from the PHY header portion of a PHY packet containing a connection response frame in response to the connection request frame, and passes the information to the CNL processing unit 102. Accordingly, the CNL processing unit 102 can grasp wireless systems supported by the other wireless communication apparatus and determine the wireless system to be used for the data exchange with the other wireless communication apparatus. When a connection request is received, the PHY processing unit 103 extracts information indicating wireless systems supported by another wireless communication apparatus from the PHY header portion of a PHY packet containing a connection request frame and passes the information to the CNL processing unit 102. Accordingly, the CNL processing unit 102 can grasp wireless systems supported by the other wireless communication apparatus and determine the wireless system to be used for the data exchange with the other wireless communication apparatus.

### Third Embodiment

In the first and second embodiments, an example is shown in which a wireless system extended by adding the transmission rate on PHY to the wireless system 1 is set as the wireless system 2. The method of distinguishing the wireless systems is not limited to the above example.

For example, the wireless system 2 may be obtained by changes on CNL, such as a function extension (function addition) of CNL to the wireless system 1. A wireless system with changes only on CNL may be distinguished as a wireless system or a wireless system with changes on both of CNL and PHY may be distinguished as a wireless system.

When, for example, two wireless systems of the wireless system 1 and the wireless system 2 are considered, the wireless system 2 may be a wireless system extended by adding the transmission rate on PHY to the wireless system 1 and further adding functions on CNL. In this case, in the method of notifying the support of the wireless system 2 at the PHY packet level like in the second embodiment, the wireless system notification field can be used not only for notification of simple extension in the transmission rates, but also for notification of function addition on CNL. That is, information about CNL is also carried at a PHY packet level.

When, for example, three wireless systems of the wireless system 1, the wireless system 2, and a wireless system 3 are considered, the wireless system 2 may be a wireless system extended by adding the transmission rate on PHY to the wireless system 1 and the wireless system 3 may be a wireless system obtained by further adding functions on CNL to the wireless system 2. In the method of notifying the support of the wireless system 2 or the wireless system 3 at the PHY packet level described in the second embodiment, the wireless system notification field can be used for notification of extension in the transmission rate or notification of extension in the transmission rate and function addition on CNL. Similar to the previous example, information about CNL is also carried at a PHY packet level.

According to the third embodiment, as described above, a wireless system changed (function addition or extension) on at least one of CNL and PHY can be regarded as a different wireless system.

### Fourth Embodiment

In the first embodiment, the same value (for example, “0x01”) is set in the LiCC version field contained in the frame body portion of a management frame regardless of the wireless system. In the fourth embodiment, by contrast, a value in accordance with the wireless system is set in the LiCC version field.

Also in the fourth embodiment, a case where two wireless systems (a wireless system 1 and a wireless system 2) as described in the first embodiment are used will mainly be described to simplify the description. The LiCC version field is set to “0x01” in a management frame related to settings of communication in the wireless system 1. On the other hand, the LiCC version field is set to “0x02” in a management frame related to settings of communication in the wireless system 2. Like in the first embodiment, a wireless communication apparatus 100 and a wireless communication apparatus 500 are assumed to be combo apparatuses supporting both of the wireless system 1 and the wireless system 2 and a wireless communication apparatus 200 is assumed to support only the wireless system 1.

In the present embodiment, when a wireless communication apparatus supporting a plurality of wireless systems makes a connection request, the wireless communication apparatus transmits a plurality of connection request frames in each of which an LiCC version of an individual wireless system is set in the LiCC version field of the frame body. A CNL processing unit 102 of a wireless communication apparatus on the receiving side performs reception processing of connection request frames in which LiCC versions of wireless systems supported by this wireless communication apparatus is set to the last. When the wireless communication apparatus on the receiving side supports a plurality of wireless systems, the wireless communication apparatus selects one wireless system (for example, the wireless system of the highest LiCC version) from these wireless systems and transmits a connection response frame in which the LiCC version of the selected wireless system is set in the LiCC version field of the frame body.

FIG. 8 shows a procedure in which the wireless communication apparatus 100 makes a connection request to establish connection to the wireless communication apparatus 200. As shown in FIG. 8, when a CNL_CONNECT.request primitive is received from a CNL User processing unit 101, the CNL processing unit 102 of the wireless communication apparatus 100 generates two frames, a C-Req frame in which “0x01” is set in the LiCC version field of the frame body and a C-Req frame in which “0x02” is set in the LiCC version field of the frame body, and transmits these C-Req frames via a PHY processing unit 103. The order of transmitting these two C-Req frames may be decided based on the priority of wireless systems. If, for example, priority should be given to connection by the wireless system 2 (N T-Jet) in the wireless communication apparatus 100, the CNL processing unit 102 first transmits a C-Req frame in which LiCC version is “0x02”. If the CNL processing unit 102 enters the two C-Req frames in a transmission queue of the CNL processing unit 102 in the order of transmission, the transmission procedure from the CNL processing unit 102 is the same as a procedure for successively transmitting two normal management frames. As an example, the inter-frame space (IFS) between two C-Req frames is an initiator IFS (IIFS) defined for TransferJet.

The wireless communication apparatus 200 successively receives and decodes the two C-Req frames from the wireless communication apparatus 100. A CNL processing unit 202 of the wireless communication apparatus 200 recognizes the frame type of the C-Req frame whose LiCC version is “0x02” as the C-Req frame, but recognizes that unsupported LiCC version is set in the stage of processing the frame body and does not perform the subsequent processing. That is, the CNL processing unit 202 of the wireless communication apparatus 200 does not make a state transition based on the C-Req frame whose LiCC version is “0x02” and does not output a primitive to a CNL User processing unit 201. If the C-Req frame is temporarily stored in a receive buffer, the CNL processing unit 202 discards the C-Req frame.

The CNL processing unit 202 of the wireless communication apparatus 200 recognizes the frame type of the C-Req frame whose LiCC version is “0x01” as the C-Req frame and then recognizes that LiCC version supported by this wireless communication apparatus 200 is set in the stage of processing the frame body and performs reception processing of the C-Req frame. That is, the CNL processing unit 202 makes a transition to the accept waiting state based on the C-Req frame whose LiCC version is “0x01” and also outputs a CNL_CONNECT.indication primitive to the CNL User processing unit 201.

When a CNL_ACCEPT.request primitive instructing the transmission of a connection response frame to the wireless communication apparatus 100 is received from the CNL User processing unit 201, the CNL processing unit 202 of the wireless communication apparatus 200 generates a C-Acc frame. The LiCC version field of the frame body of the C-Acc frame is set to “0x01”. Subsequently, the CNL processing unit 202 transmits the C-Acc frame via the PHY processing unit 203.

The CNL processing unit 102 of the wireless communication apparatus 100 receives the C-Acc frame from the wireless communication apparatus 200 via the PHY processing unit 103. The CNL processing unit 102 recognizes that LiCC version is “0x01”, that is, the wireless communication apparatus 200 supports the wireless system 1 in the stage of processing the frame body of the C-Acc frame. The CNL processing unit 102 holds information that the wireless communication apparatus 200 supports the wireless system 1 and outputs a CNL_ACCEPT.indication primitive to the CNL User processing unit 101. Then, when a CNL_ACCEPT.response primitive is received from the CNL User processing unit 101, the CNL processing unit 102 checks the identifier of the wireless communication apparatus (the wireless communication apparatus 200 in the example of FIG. 8) specified by the CNL_ACCEPT.response primitive, recognizes the wireless system supported by the wireless communication apparatus 200, that is, recognizes that the wireless system 1 is to be used for data exchange with the wireless communication apparatus 200, and also responds with an ACK frame to a C-Acc frame received again from the wireless communication apparatus 200.

Although the frame body of the C-Acc frame received again has “0x01” as a LiCC version, the CNL processing unit 102 of the wireless communication apparatus 100 may transmit an ACK frame without reconfirming the LiCC version in the C-Acc frame. This is because an ACK response to a C-Acc frame is transmitted in the shortest IFS, SIFS (Short IFS) in TransferJet, and determining whether to transmit an ACK frame after checking the contents of the frame body in the shortest IFS is considered to be severely restricted by time. The processing of deciding whether to transmit an ACK frame in response to a C-Acc frame is assumed to be the same under other conditions in the present embodiment. On the other hand, the wireless communication apparatus 200 confirms the reception of an ACK frame in response to the transmitted C-Acc frame from the wireless communication apparatus 100 and recognizes that data can now be exchanged by using the wireless system 1. Conditions for the state transition depending on primitives and received frames by each wireless communication apparatus including those in subsequent examples are the same as in the first embodiment.

Next, a case when wireless communication apparatuses supporting the wireless system 1 and the wireless system 2 perform communication will be described. FIG. 9 shows a state in which the wireless communication apparatus 100 makes a connection request to establish connection to the wireless communication apparatus 500. Also in the example of FIG. 9, as described with reference to FIG. 8, the wireless communication apparatus 100 transmits two C-Req frames to make a connection request.

When a C-Req frame whose LiCC version is “0x02” is received, a CNL processing unit 502 of the wireless communication apparatus 500 recognizes that the LiCC version is a value of a wireless system supported by this wireless communication apparatus 500 and performs reception processing of the C-Req frame. That is, the CNL processing unit 502 of the wireless communication apparatus 500 makes a transition to the accept waiting state based on the C-Req frame if the current state is the search state and outputs a CNL_CONNECT.indication primitive to a CNL User processing unit 501. In FIG. 9, the CNL processing unit 502 of the wireless communication apparatus 500 receives the C-Req frame whose LiCC version is “0x01” thereafter. Like when LiCC version is “0x02”, the CNL processing unit 502 may output a primitive to the CNL User processing unit 501 after recognizing that LiCC version is a value of a wireless system supported by this wireless communication apparatus 500. In this case, the CNL processing unit 502 of the wireless communication apparatus 500 accepts the C-Req frame, but the state thereof is already the accept waiting state and the state transition is not needed. Alternatively, when the wireless communication apparatus 500 supports the wireless system 2 having backward compatibility with the wireless system 1, the CNL processing unit 502 of the wireless communication apparatus 500 may omit a primitive output corresponding to the C-Req frame to the CNL User processing unit 501 when a C-Req frame is received from the same wireless communication apparatus as in this case. When, for example, a C-Req frame whose LiCC version is “0x01” is received after a C-Req frame whose LiCC version is “0x02” is received, the CNL processing unit 502 does not output a CNL_CONNECT.indication primitive indicating the reception of a C-Req frame whose LiCC version is “0x01”, that is, ignores the C-Req frame whose LiCC version is “0x01”. In view of the possibility of receiving C-Req frames of a plurality of LiCC versions, the CNL processing unit 502 of the wireless communication apparatus 500 adjusts the time so that a plurality of types of C-Req frames can be received before the generation of a C-Acc frame described later and the supported wireless system can be recognized, or may observe C-Req frames until a C-Req frame of the same LiCC version is received from the same wireless communication apparatus. The transmission interval of C-Req frames is fixed in TransferJet and if, following the policy, all supported wireless systems are notified by C-Req frames within the fixed period, it is needless to say that only the fixed period needs to be observed. Alternatively, if a notification is made in descending order of the LiCC versions of the wireless systems, or in other words, starting with the latest wireless system, as a protocol, at least the arrival of notification of the wireless system supported by the concerned wireless communication apparatus may be awaited. Accordingly, the CNL processing unit 502 of the wireless communication apparatus 500 recognizes that the wireless communication apparatus 100 supports the wireless system 1 and the wireless system 2 and holds the information. However, if a trial of connection processing is made by one wireless system only, for example, the wireless system of the higher LiCC version, in other words, the succeeding or latest wireless system, only the one wireless system based on the selection policy may be held by associating with the identifier of the wireless communication apparatus. Alternatively, if one wireless system is selected by taking, for example, receiving states of the C-Req frames into consideration, information about the other wireless system may be deleted when the one wireless system is selected.

When a CNL_ACCEPT.request primitive as a transmission instruction of a connection response frame to the wireless communication apparatus 100 is received from the CNL User processing unit 501, the CNL processing unit 502 of the wireless communication apparatus 500 generates a C-Acc frame. At this point, the LiCC version of the wireless system selected as described above is set in the LiCC version field in the frame body of the C-Acc frame. In the example of FIG. 9, the wireless system 2 is selected. The CNL processing unit 502 of the wireless communication apparatus 500 transmits the C-Acc frame via a PHY processing unit 503.

By receiving the C-Acc frame whose LiCC version is “0x02” from the wireless communication 500, the CNL processing unit 102 of the wireless communication apparatus 100 recognizes that the wireless communication apparatus 500 supports the wireless system 2, holds the information, and outputs a CNL_ACCEPT.indication primitive to the CNL User processing unit 101. Subsequently, when a CNL_ACCEPT.response primitive is received from the CNL User processing unit 101, the CNL processing unit 102 checks the identifier of the target wireless communication apparatus (in the example of FIG. 9, the wireless communication apparatus 500) and recognizes the wireless system supported by the wireless communication apparatus 500, that is, recognizes that the wireless system 2 is used for data exchange with the wireless communication apparatus 500, and also responds with an ACK frame in response to a C-Acc frame received again from the wireless communication apparatus 500. On the other hand, the wireless communication apparatus 500 confirms the reception of an ACK frame from the wireless communication apparatus 100 in response to the C-Acc frame which is transmitted by this apparatus 500 and whose LiCC version is “0x02” and recognizes that data can now be exchanged by using the wireless system 2.

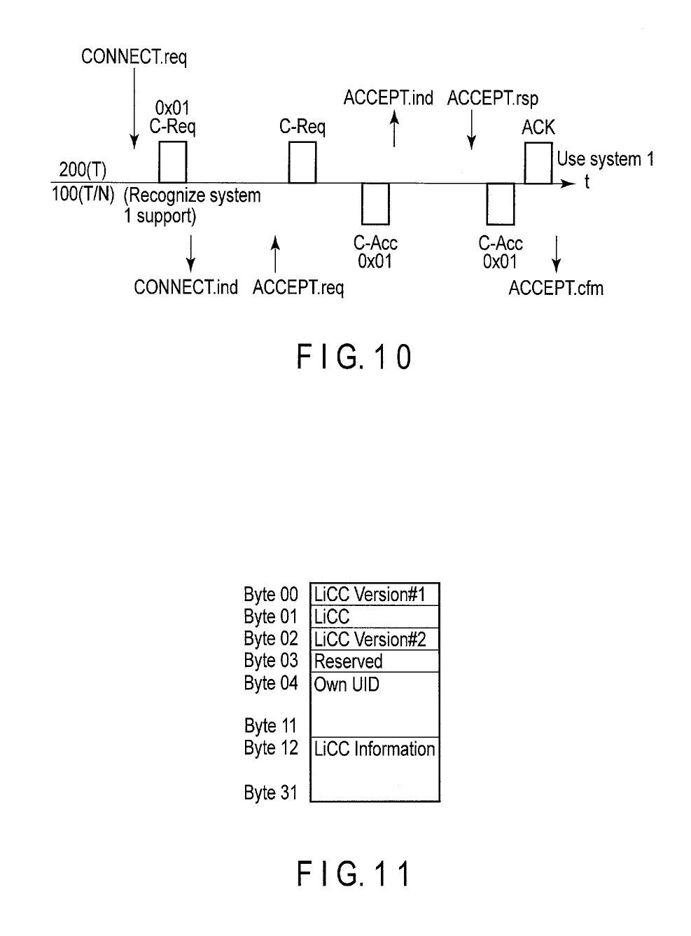

Next, a case where the wireless communication apparatus 200 makes a connection request to establish connection to the wireless communication apparatus 100 will be described with reference to FIG. 10. The wireless communication apparatus 200 supports only the wireless system 1 and so transmits only one type of C-Req frame, that is, a C-Req frame whose LiCC version is “0x01”. The wireless communication apparatus 100 grasps that the wireless communication apparatus 200 transmits only C-Req frames whose LiCC version is “0x01” by, for example, making observations for a fixed time, thereby recognizing that the wireless communication apparatus 200 supports only the wireless system 1. When a CNL_ACCEPT.request primitive in which the wireless communication apparatus 200 is specified as the target wireless communication apparatus is received from the CNL User processing unit 101, the CNL processing unit 102 of the wireless communication apparatus 100 generates a C-Acc frame whose LiCC version is “0x01” and transmits the C-Acc frame via the PHY processing unit 103. The subsequent processing is the same as that described with reference to FIG. 7 in the first embodiment and thus the description thereof is omitted.

The interval between C-Req frames providing notification of different wireless systems may be, instead of using the above IIFS, such that a C-Acc frame can be accepted therebetween. Alternatively, for wireless systems whose LiCC version is, for example, “0x02” or higher, by transmitting a C-Acc frame based on reception of a C-Req frame whose LiCC version is “0x01” and by transmitting C-Req frames in descending order of version numbers where the C-Req frame with “0x01” being the last frame, C-Req frames of a series of different wireless systems can be transmitted in a burst by using, for example, the IIFS as described above and the period of the next periodic burst transmission may be set relative to the C-Req frame transmitted last and whose LiCC version is “0x01”.

In a wireless communication apparatus according to the fourth embodiment, as described above, when a connection request is made, the CNL processing unit 102 generates and transmits a plurality of connection request frames corresponding to a plurality of wireless systems, respectively. This makes it possible to establish connection to another wireless communication apparatus supporting at least one of these wireless systems. Further, the CNL processing unit 102 grasps wireless systems supported by another wireless communication apparatus based on the connection response frame received from the other wireless communication apparatus. Accordingly, the CNL processing unit 102 can decide the wireless system used for data exchange with the other wireless communication apparatus. Also, by successively transmitting connection request frames corresponding to a plurality of wireless systems and waiting for connection response frames, the reception of a connection response frame corresponding to any one wireless system can be expected within a single connection response frame reception waiting time so that the wireless system used for data exchange can be decided efficiently. When connection request frames corresponding to wireless systems are transmitted with a transmission interval between the connection request frames so that a connection response frame can be accepted right after each of the connection request frame, a connection response frame for a wireless system of high priority (that is, notified earlier) can be accepted earlier so that a wireless communication apparatus to be a candidate of a communication partner in a wireless system of higher priority can be grasped earlier. When a connection request is received, the CNL processing unit 102 grasps a wireless system supported by another wireless communication apparatus based on the connection request frame received from the other wireless communication apparatus. Accordingly, the CNL processing unit 102 can determine the wireless system used for data exchange with the other wireless communication apparatus.

### Fifth Embodiment

In the fourth embodiment, a plurality of C-Req frames having different LiCC versions are transmitted. In the fifth embodiment, by contrast, LiCC versions of a plurality of supported wireless systems are set in a single C-Req frame.

The frame body of a management frame of TransferJet includes fields of the LiCC version described above, LiCC indicating the type of the management frame such as a C-Req frame and C-Acc frame, Own UID indicating the identifier of a wireless communication apparatus transmitting a management frame, and LiCC information in which information from the CNL User processing unit 101 is set. In the present embodiment, a plurality of fields in each of which a LiCC version is set are provided so that a plurality of supported wireless systems can be notified. FIG. 11 shows an example of the frame body of a management frame according to the present embodiment. Conventionally, one LiCC version is set in Byte 00-th position (corresponding to a portion denoted by LiCC version #1 in FIG. 11), LiCC is set in Byte 01-th position, and Byte 02-th and Byte 03-th positions are reserved. In the present embodiment supporting a plurality of wireless systems, the LiCC version of the wireless system which is the minimum target on backward compatibility is set in the field of LiCC version #1 and a LiCC version of the other wireless system is set in the field of LiCC version #2. FIG. 11 shows an example in which two wireless systems are notified. If, for example, the third wireless system should also be notified, the Byte 03-th reserved field in FIG. 11 may be used as the field of LiCC version #3 and the third wireless system may be set here. If there are not enough fields in a single frame, wireless systems that could not be included can be notified by another management frame in which a LiCC version of the wireless system of the minimum target on backward compatibility among wireless systems is set in the field of LiCC version #1 or another management frame in which one of the wireless system notified within the management frame is temporarily set in the field of LiCC version #1 as the wireless system intended as the minimum target on backward compatibility within the management frame using the field of LiCC version #2 or even by using the field of LiCC version #3. In this case, the method is like a combination with the fourth embodiment in which a plurality of C-Req frames is transmitted. The wireless system as the minimum target on backward compatibility is, for example, the wireless system 1 when the wireless system 2 guarantees backward compatibility of the wireless system 1 and is the wireless system 1 when the wireless system 3 guarantees backward compatibility of the wireless system 1 and the wireless system 2.

For example, the wireless communication apparatus 100 supporting the wireless system 1 and the wireless system 2 transmits a C-Req frame in which a LiCC version of the wireless system 1 is set in the LiCC version #1 field of FIG. 11 and a LiCC version of the wireless system 2 is set in the LiCC version #2 field of FIG. 11. The wireless communication apparatus 200 only supports the wireless system 1 and so reads the LiCC version #1 field of the C-Req frame as a conventional LiCC version field and ignores the LiCC version #2 field as a reserved field. As a result, the wireless communication apparatus 200 generates and transmits a C-Acc frame in which LiCC version of the wireless system 1 is set in the LiCC version #1 field and the LiCC version #2 field is handled as undefined by entering “0” in all bits of the field. By receiving the C-Acc frame, the wireless communication apparatus 100 grasps that the wireless communication apparatus 200 supports only the wireless system 1. The subsequent processing is the same as the procedure in the first embodiment. On the other hand, when the wireless communication apparatus 500 supporting the wireless system 1 and the wireless system 2 receives the C-Req frame, the wireless communication apparatus 500 also recognizes the value set in the LiCC version #2 field and grasps that the wireless communication apparatus 100 supports both of the wireless system 1 and the wireless system 2. When the wireless communication apparatus 500 is to connect to the wireless communication apparatus 100 by selecting the wireless system 2, the wireless communication apparatus 500 transmits a C-Acc frame in which the LiCC version of the wireless system 2 is set in LiCC version #1. In such a case, a plurality of LiCC version fields in a C-Req frame are used, but in other management frames, only a LiCC version of the determined wireless system is set in the LiCC version #1 field. If, for example, the wireless system is determined by exchanging three management frames from any generation of the wireless systems, the C-Acc frame may be enabled to make a notification of a plurality of wireless systems. In this case, for example, a new third management frame is transmitted from the wireless communication apparatus having transmitted a C-Req frame as a first management frame and a LiCC version of the determined wireless system is notified by the third management frame.

In a wireless communication apparatus according to the fifth embodiment, as described above, when a connection request is made, the CNL processing unit 102 generates and transmits a connection request frame for notification of the support of a plurality of wireless systems. This makes it possible to establish connection to another wireless communication apparatus supporting at least one of these wireless systems. Furthermore, the CNL processing unit 102 receives a connection response frame in response to the connection request frame from another wireless communication apparatus and grasps wireless systems supported by the other wireless communication apparatus based on the received connection response frame. Accordingly, the CNL processing unit 102 can determine the wireless system used for data exchange with the other wireless communication apparatus.

### Sixth Embodiment

In the fourth embodiment, a plurality of C-Req frames each having a different LiCC version in the frame body are transmitted. In the sixth embodiment, by contrast, a C-Req frame is transmitted at one of the transmission rates within each of a plurality of wireless systems. For example, the lowest transmission rate is selected for each of the wireless systems. A wireless communication apparatus that can receive and decode a C-Req frame by a PHY processing unit 103 supports the wireless system including the transmission rate at which the C-Req frame is transmitted, and thus supports the wireless system supported by a wireless communication apparatus which is the transmission source of the C-Req frame.

Like in the first embodiment, a wireless communication apparatus 100 and a wireless communication apparatus 500 are assumed to be combo apparatuses supporting both of a wireless system 1 and a wireless system 2 and a wireless communication apparatus 200 is assumed to support only the wireless system 1.

When a wireless communication apparatus supporting the wireless system 1 and the wireless system 2 (for example, the wireless communication apparatus 100 or the wireless communication apparatus 500) transmits a C-Req frame, the wireless communication apparatus transmits the C-Req frame at each of the transmission rate selected from the wireless system 1 and the transmission rate selected from the wireless system 2. In each of the PHY packet carrying a C-Req frame, the transmission rate used is set in the Rate field of the PHY header. That is, the transmission rate selected for transmission of the payload portion from the transmission rates of the wireless system 1 is set in the Rate field of the PHY header in the PHY packet transmitting the C-Req frame by the wireless system 1 and the transmission rate selected for transmission of the payload portion from the transmission rates of the wireless system 2 is set in the Rate field of the PHY header in the PHY packet transmitting the C-Req frame by the wireless system 2.

In the wireless communication apparatus 100 according to the present embodiment, for example, when a CNL_CONNECT.request primitive as a control signal related to the start instruction of connection settings is received from a CNL User processing unit 101, like in the fourth embodiment, a CNL processing unit 102 generates two C-Req frames. In this case, the CNL processing unit 102 instructs the PHY processing unit 103 to transmit the two C-Req frames at transmission rates of different wireless systems. The transmission rate instruction from the CNL processing unit 102 to the PHY processing unit 103 may follow the conventional technique. For example, a transmission rate “a” of the wireless system 1 is assumed to be selected as the transmission rate when a management frame is transmitted by the wireless system 1 and a transmission rate “A” of the wireless system 2 is assumed to be selected as the transmission rate when a management frame is transmitted by the wireless system 2.

Alternatively, after generating a C-Req frame upon receipt of a CNL_CONNECT.request primitive, the CNL processing unit 102 may instruct the PHY processing unit 103 to transmit the C-Req frame at transmission rates of different wireless systems, i.e., at the transmission rate “a” and the transmission rate “A”, as in the above example. In this case, the PHY processing unit 103 may be created as a structure to accept a transmission instruction of a plurality of transmission rates so that when a transmission instruction of a plurality of transmission rates is received, the PHY processing unit 103 copies as many pieces of payload information passed from the CNL processing unit 102 as the instructed number of transmission rates and generates each PHY packet associated with each instructed transmission rate.

It is assumed below that as many C-Req frames as the number of supported wireless systems by the CNL processing unit 102 are generated, but when as many PHY packets as the number of supported wireless systems are generated from one payload by the PHY processing unit 103, the way of consideration is the same based on the above processing.

As an example, the transmission rate of the PHY header portion is common to the wireless system 1 and the wireless system 2. In this manner, the transmission rate first on standby between wireless systems, that is, the transmission rate for PHY header processing can be made common so that standby processing of a wireless communication apparatus supporting a plurality of wireless systems can be simplified. In this case, the transmission rate of the PHY header portion by the wireless system 1 is used as the transmission rate of the PHY header portion by the wireless system 2 which is a succeeding system of the wireless system 1.

In this case, a PHY processing unit 203 of the wireless communication apparatus 200 can receive and decode the PHY header portion. If, for example, the first C-Req frame is transmitted from the wireless communication apparatus 100 by the wireless system 2 and received by the wireless communication apparatus 200, the PHY header portion is received and decoded and an attempt is made to read the Rate field in which the transmission rate “A” is set and a reception error occurs because a value undefined in the wireless system 1 is set there. In the wireless communication apparatus 200, a reception error of a PHY packet containing the C-Req frame occurs in the PHY processing unit 203 and so the PHY processing unit 203 terminates the processing without passing the payload portion to the CNL processing unit 202. Next, when the second C-Req frame is transmitted from the wireless communication apparatus 100 by the wireless system 1, the Rate field of the PHY header portion shows the transmission rate “a” defined in the wireless system 1 and thus, the PHY processing unit 203 of the wireless communication apparatus 200 can recognize the value of the Rate field and, if the whole PHY packet can be received, passes the payload portion to the CNL processing unit 202 as usual and the CNL processing unit 202 performs connection processing as that the C-Req frame has been received. Because the wireless communication apparatus 200 supports only the wireless system 1, the connection processing here is connection processing for the wireless system 1. In the wireless communication apparatus 200, like in the fourth embodiment, when the CNL User processing unit 201 instructs the CNL processing unit 202 to perform connection processing to the wireless communication apparatus 100, which is the transmission source of the received C-Req frame, through CNL_ACCEPT.response, the CNL processing unit 202 generates a C-Acc frame and passes the C-Acc frame to the PHY processing unit 203 and the PHY processing unit 203 naturally selects the transmission rate from the wireless system 1, sets the transmission rate in the Rate field, and generates and transmits a PHY packet having a payload portion using the selected transmission rate.

On the other hand, in the wireless communication apparatus 100, particularly in the present embodiment, the CNL processing unit 102 needs to acquire information about what is written in the Rate field of the PHY header portion contained in the received C-Req frame together with the payload portion. When a C-Acc frame is received from the wireless communication apparatus 200, the transmission rate “a” is set in the Rate field and the PHY processing unit 103 notifies the CNL processing unit 102 of the payload portion and the information about the transmission rate when the PHY packet containing the C-Acc frame is correctly received. The notification method may follow a conventional technique in which an upper processing unit with respect to the PHY processing recognizes the transmission rate of a received packet. The CNL processing unit 102 recognizes that the C-Acc frame has been transmitted at the transmission rate “a”, that is, by the wireless system 1. The subsequent connection processing is basically the same as in the fourth embodiment.

When the wireless communication apparatus 500 receives two C-Req frames from the wireless communication apparatus 100, a PHY processing unit 503 can receive and decode both of the frames and pass the frames to the CNL processing unit 502. Like the PHY processing unit 103 of the wireless communication apparatus 100, when passing the payload to the CNL processing unit 502, the PHY processing unit 503 of the wireless communication apparatus 500 also passes information about the transmission rate of the payload portion of the received PHY packet. Therefore, when two C-Req frames are both correctly received, the CNL processing unit 502 recognizes that the C-Req frames are received from the same wireless communication apparatus (for example, the wireless communication apparatus 100) by two different wireless systems (the wireless system 1 and the wireless system 2) and holds the information that the wireless communication apparatus 100 supports the wireless system 1 and the wireless system 2. The processing to output a CNL_CONNECT.indication primitive as notification of the reception of a C-Req frame from the CNL processing unit 502 to the CNL User processing unit 501 is the same as in the fourth embodiment. Then, when a transmission instruction of a connection response to the wireless communication apparatus 100 is received from the CNL User processing unit 501 through a CNL_ACCEPT.response primitive, like in the fourth embodiment, the CNL processing unit 502 selects the wireless system to be used and generates a C-Acc frame. When, for example, the wireless system 2 is selected as the wireless system to be used, the CNL processing unit 502 instructs the transmission at the transmission rate “A” when passing the C-Acc frame to the PHY processing unit 503.

When a PHY packet containing the C-Acc frame is received from the wireless communication apparatus 500, the PHY processing unit 103 of the wireless communication apparatus 100 notifies the CNL processing unit 102 that the PHY packet has been transmitted at the transmission rate “A” when passing the payload portion. Accordingly, the CNL processing unit 102 recognizes that the wireless communication apparatus 500 has responded by the wireless system 2. The subsequent connection processing is basically the same as in the fourth embodiment.

When a C-Req frame is received by the wireless communication apparatus 100 from the wireless communication apparatus 200, the wireless system may be recognized in the same manner as when the above C-Acc frame is received. In this case, only the wireless system 1 is recognized.

As another example, the transmission rate of the PHY header portion is different between the wireless system 1 and the wireless system 2. By making the transmission rate of the PHY header portion in the wireless system 2 higher than that in the wireless system 1, the occupation time on a wireless medium of a PHY packet itself can be reduced more, and for a wireless communication apparatus supporting both wireless systems, by which PHY header processing on standby a PHY packet is received and decoded directly leads to recognizing the wireless system so that information about the wireless system can be recognized at an earlier stage. In this case, instead of information of the Rate field, information about by which PHY header processing on standby for the wireless system 1 or the wireless system 2 a C-Req frame is received and decoded is passed to the CNL processing unit 102 together with the payload.

The PHY processing unit 203 of the wireless communication apparatus 200 fails in reception and decoding of the PHY header portion of a PHY packet containing the C-Req frame transmitted by the wireless system 2. That is, a reception error occurs. When the wireless system 1 is T-Jet conforming to the ECMA-398 standard, a preamble field and a Sync field are provided prior to the PHY header by the PHY processing unit 103 and (after starting reception processing of a PHY packet by recognizing the preamble field) when the PHY processing unit 103 detects pattern matching of the Sync field or the PHY header, the information is passed from the PHY processing unit 103 to the CNL processing unit 102 and the CNL processing unit 102 grasps that the wireless medium is busy. Therefore, when a PHY packet containing a C-Req frame is transmitted by the wireless system 2, to cause the wireless communication apparatus 200 to grasp the occupation of a wireless medium, that is, that the wireless medium is busy, it is desirable to make at least the preamble field and the Sync field in the wireless system 2 common to T-Jet conforming to the ECMA-398 standard of the wireless system 1. A PHY packet containing a C-Req frame transmitted by the wireless system 1 is processed in the same manner as the above example in which the transmission rate of the PHY header portion is common to the wireless system 1 and the wireless system 2.

The processing when the wireless communication apparatus 500 receives each of C-Req frames transmitted by the wireless system 2 and the wireless system 1 is basically the same as the above example in which the transmission rate of the PHY header portion is common to the wireless system 1 and the wireless system 2. However, when passing the payload to the CNL processing unit 102, instead of information of the Rate field, the PHY processing unit 103 provides notification of information of by which PHY header processing on standby a C-Req frame is received and decoded, that is, information about whether a C-Req frame is received by the wireless system 1 or the wireless system 2. Naturally, when the CNL processing unit 102 wants to use information of the transmission rate actually used for transmission of the payload portion, supported wireless systems may be notified by the PHY processing unit 103 together with the transmission rate or only information of the Rate field may be notified in substantially the same manner as when the transmission rate of the PHY header portion is common to the wireless system 1 and the wireless system 2.

The processing operation at each wireless communication apparatus after the C-Req frame is transmitted/received is the same as the above example in which the transmission rate of the PHY header portion is common to the wireless system 1 and the wireless system 2.

Also, when the wireless communication apparatus 100 receives a C-Req frame from the wireless communication apparatus 200, the wireless communication apparatus 100 grasps the wireless system supported by the wireless communication apparatus 200 in the same manner as when the wireless communication apparatus 500 receives a C-Req frame from the wireless communication apparatus 100. In this case, the wireless communication apparatus 100 grasps that the wireless communication apparatus 200 supports only the wireless system 1.

In a wireless communication apparatus according to the sixth embodiment, as described above, when a connection request is made, a connection request frame is transmitted at one of the transmission rates within each of a plurality of wireless systems. This makes it possible to establish connection to another wireless communication apparatus supporting at least one of these wireless systems. Further, the PHY processing unit 103 provides, to the CNL processing unit 102, information about at which transmission rate the PHY packet containing a connection response frame has been transmitted. Based on this information, the CNL processing unit 102 grasps wireless systems supported by another wireless communication apparatus. Accordingly, the CNL processing unit 102 can determine the wireless system used for data exchange with the other wireless communication apparatus. When a connection request is received, the PHY processing unit 103 provides, to the CNL processing unit 102, information about at which transmission rate the PHY packet containing a connection request frame has been transmitted from another wireless communication apparatus. Based on this information, the CNL processing unit 102 grasps wireless systems supported by the other wireless communication apparatus. Accordingly, the CNL processing unit 102 can determine the wireless system used for data exchange with the other wireless communication apparatus.

### Seventh Embodiment

In the fourth embodiment, when a start instruction of connection settings is received, the CNL processing unit 102 of a wireless communication apparatus supporting a plurality of wireless systems generates a plurality of C-Req frames corresponding to the plurality of wireless systems and instructs the PHY processing unit 103 to transmit these frames and waits to receive a C-Acc frame corresponding to one of these wireless systems. In the seventh embodiment, a CNL processing unit 102 first generates a C-Req frame corresponding to one wireless system, instructs a PHY processing unit 103 to transmit the C-Req frame, and waits for the reception of a C-Acc frame for a predetermined time and if no C-Acc frame is received, the CNL processing unit 102 generates a C-Req frame corresponding to another wireless system, instructs the PHY processing unit 103 to transmit the C-Req frame, and waits for the reception of a C-Acc frame for the predetermined time.

Like in the first embodiment, a wireless communication apparatus 100 and a wireless communication apparatus 500 are assumed to be wireless communication apparatuses supporting both of a wireless system 1 and a wireless system 2 and a wireless communication apparatus 200 is assumed to be a wireless communication apparatus only supporting the wireless system 1.

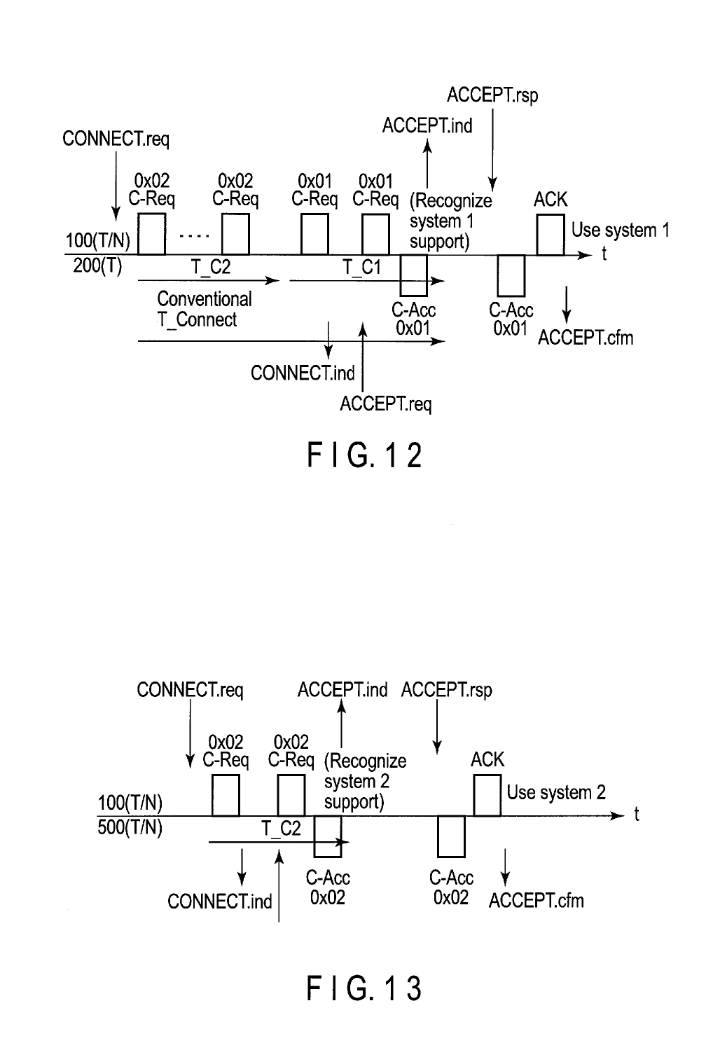

FIG. 12 shows a procedure where the wireless communication apparatus 100 establishes wireless connection to the wireless communication apparatus 200 after making a connection request from the viewpoint of focusing on the CNL processing unit 102 of the wireless communication apparatus 100 and a CNL processing unit 202 of the wireless communication apparatus 200. In the example of FIG. 12, the wireless system chosen for data exchange is the wireless system 1.

When a CNL_CONNECT.request primitive as a control signal related to a start instruction of the connection start is received from a CNL User processing unit 101, the CNL processing unit 102 of the wireless communication apparatus 100 generates a C-Req frame corresponding to, for example, the latest wireless system (in this example, the wireless system 2) among the supported wireless systems. The C-Req frame has, like in the fourth embodiment, “0x02” set in the LiCC version field of the frame body. The CNL processing unit 102 instructs the PHY processing unit 103 to transmit the C-Req frame and also activates a timer to wait for a C-Acc frame. For the sake of convenience, the time-out period of the timer for the wireless system 2 is set here to T_C2. Then, while transmitting the C-Req frame periodically, if a C-Acc frame is received within the time-out period of T_C2, connection processing is performed based on the C-Acc frame. In this example, the wireless communication apparatus 200 receiving a C-Req frame does not support the wireless system 2 and so the wireless communication apparatus 200 does not respond to a C-Req frame whose LiCC version is “0x02”. As a result, the timer time-outs after T_C2. When the timer waiting for a C-Acc frame time-outs after T_C2, the CNL processing unit 102 sets the time-out period for the wireless system 1 to the timer and activates the timer. For the sake of convenience, the time-out period for the wireless system 1 is set here to T_C1. The C-Req frame transmitted at this point has “0x01” as a LiCC version. While transmitting the C-Req frame periodically, whether a C-Acc frame is received within the time-out period of T_C1 is checked. In this example, the wireless communication apparatus 200 receives the C-Req frame and in a procedure similar to the procedure in the above embodiments, the CNL processing unit 202 of the wireless communication apparatus 200 outputs a CNL_CONNECT.indication primitive to a CNL User processing unit 201 and receives, from the CNL User processing unit 201, a CNL_ACCEPT.response primitive providing notification of a connection response instruction to the wireless communication apparatus 100. The wireless communication apparatus 200 transmits a C-Acc frame whose LiCC version is “0x01”. The wireless communication apparatus 100 receives the C-Acc frame through the CNL processing unit 102 before the time-out period of T_C1 elapses. Thus, the CNL processing unit 102 of the wireless communication apparatus 100 recognizes that the wireless communication apparatus 200 as the transmission source supports the wireless system 1 from the received C-Acc frame and, like in the fourth embodiment, holds the information. The subsequent processing is the same as in the fourth embodiment.

FIG. 13 shows a procedure when the wireless communication apparatus 100 establishes wireless connection to the wireless communication apparatus 500 after making a connection request from the viewpoint of focusing on the CNL processing unit 102 of the wireless communication apparatus 100 and a CNL processing unit 502 of the wireless communication apparatus 500. In the example of FIG. 13, the wireless system chosen for data exchange is the wireless system 2.

The CNL processing unit 502 of the wireless communication apparatus 500 can recognize a C-Req frame whose LiCC version is “0x02” and the CNL processing unit 502 thereby outputs a CNL_CONNECT.indication primitive to a CNL User processing unit 501 in a procedure similar to the procedure described in the above embodiments. Subsequently, when a CNL_ACCEPT.response primitive providing notification of a connection response instruction to the wireless communication apparatus 100 is received from the CNL User processing unit 501, the CNL processing unit 502 transmits a C-Acc frame whose LiCC version is “0x02”. The wireless communication apparatus 100 receives the C-Acc frame through the CNL processing unit 102 before the time-out period of T_C2 elapses. The CNL processing unit 102 of the wireless communication apparatus 100 recognizes that the wireless communication apparatus 500 as the transmission source supports the wireless system 2 from the received C-Acc frame and, like in the fourth embodiment, holds the information. The subsequent processing is the same as in the fourth embodiment. Having received the C-Acc frame before the time-out period of T_C2 elapses, the CNL processing unit 102 of the wireless communication apparatus 100 does not set T_C1 to the timer and does not transmit a C-Req frame whose LiCC version is “0x01”.

When the wireless communication apparatus 200 makes a connection request, the method of transmitting a C-Req frame is no different from the method in the fourth embodiment because it only supports one wireless system.

If the time-out period of the timer waiting for a C-Acc frame is T_Connect for a wireless communication apparatus only supporting the wireless system 1, it is desirable to set T_C2+T_C1=T_Connect, as appended to FIG. 12. In consideration of an occurrence of margin for timer activation, it is desirable to set the total of time-out periods and the margin to become equal to T_Connect when the timers are serially activated for a plurality of wireless systems. This is because the CNL User processing unit 101 waits to see whether there is any partner for connection processing regardless of the wireless systems and assumes that the CNL processing unit 102 is operating according to conventional T_Connect. If the value of T_Connect can be set to any value, it is desirable to set the value larger when a notification of a plurality of wireless systems is made compared with a case when a notification of a single wireless system is made.

In a wireless communication apparatus according to the seventh embodiment, as described above, when a connection request is made, the CNL processing unit 102 first generates a connection request frame corresponding to one wireless system, instructs the PHY processing unit 103 to transmit the connection request frame, and waits for the reception of a connection response frame for a predetermined time and if no connection response frame is received, the CNL processing unit 102 generates a connection request frame corresponding to another wireless system, instructs the PHY processing unit 103 to transmit the connection request frame, and waits for the reception of a connection response frame for the predetermined time. Accordingly, connection to another wireless communication apparatus supporting at least one of the wireless systems supported by the local apparatus can be established. Furthermore, by first transmitting a connection request frame corresponding to a desired wireless system and by waiting for the reception of a connection response frame, the desired wireless system can be preferentially selected.

### Eighth Embodiment

The eighth embodiment is related to a modification of the seventh embodiment and, like in the sixth embodiment, connection request frames are transmitted at different transmission rates.

The procedure according to the present embodiment when a wireless communication apparatus 100 establishes connection to a wireless communication apparatus 200 after making a connection request will be described by referring to FIG. 12 again. The wireless communication apparatus 100 transmits, instead of a C-Req frame whose LiCC version is “0x02”, a PHY packet containing a C-Req frame at a transmission rate of the wireless system 2 and waits for a response of a C-Acc frame thereto for the T_C2 time. After the time-out of T_C2, while reactivating the timer by setting T_C1 as the time-out period, the wireless communication apparatus 100 transmits, instead of a C-Req frame whose LiCC version is “0x01”, a PHY packet containing a C-Req frame at a transmission rate of the wireless system 1 and waits for a response of a C-Acc frame thereto for the T_C1 time. The wireless communication apparatus 200 naturally transmits a C-Acc frame at the transmission rate of the wireless system 1.

The procedure according to the present embodiment when the wireless communication apparatus 100 establishes connection to a wireless communication apparatus 500 after making a connection request will be described by referring to FIG. 13 again. In the present embodiment, the wireless communication apparatus 500 performs reception processing of a C-Req frame transmitted at the transmission rate of the wireless system 2 and when generating a C-Acc frame, a CNL processing unit 502 of the wireless communication apparatus 500 instructs a PHY processing unit 503 to transmit the C-Acc frame at the transmission rate of the wireless system 2. In the present embodiment, however, the C-Acc frame does not need to be transmitted in the wireless system 2. This is because after having responded with a C-Acc frame in the transmission phase of a C-Req frame transmitted at the transmission rate of the wireless system 2, the wireless communication apparatus 100 can recognize that the wireless communication apparatus 500 supports the wireless system 2. In this case, the C-Acc frame may be transmitted at the transmission rate of the wireless system 1. Alternatively, depending on what the transmission rate of a C-Acc frame which is responded during transmission phase of a C-Req frame of a certain wireless system is, the wireless system desired to be used by the side of the wireless communication apparatus 500 can be notified. For example, data communication may be performed by the wireless system 2 when the wireless communication apparatus 500 transmits a C-Acc frame at the transmission rate of the wireless system 2 and data communication may be performed by the wireless system 1 when the wireless communication apparatus 500 transmits a C-Acc frame at the transmission rate of the wireless system 1. In this manner, when, for example, power consumption should be limited in view of remaining battery life or power supply conditions on the receiving side of the C-Req frame, the wireless system taking such circumstances into consideration can be selected.

In a wireless communication apparatus according to the eighth embodiment, as described above, when a connection request is made, the CNL processing unit 102 transmits a connection request frame at one of transmission rates of each of a plurality of wireless systems. This makes it possible to establish connection to another wireless communication apparatus supporting at least one of these wireless systems. Furthermore, the PHY processing unit 103 provides, to the CNL processing unit 102, information indicating the transmission rate at which the PHY packet containing a connection response frame has been transmitted. Based on this information, the CNL processing unit 102 grasps wireless systems supported by another wireless communication apparatus. Accordingly, the CNL processing unit 102 can determine the wireless system used for data exchange with the other wireless communication apparatus. When a connection request is received, the PHY processing unit 103 provides, to the CNL processing unit 102, information indicating the transmission rate at which the PHY packet containing a connection request frame has been transmitted from another wireless communication apparatus. Based on this information, the CNL processing unit 102 grasps wireless systems supported by the other wireless communication apparatus. Accordingly, the CNL processing unit 102 can determine the wireless system used for data exchange with the other wireless communication apparatus.

### Ninth Embodiment

In the ninth embodiment, different frequency bands are used for different wireless systems. In the present embodiment, a case where a wireless communication apparatus supports two wireless systems is taken as an example to simplify the description. When a wireless communication apparatus supports three wireless systems or more, wireless systems are not limited to examples in which all wireless systems use mutually different frequency bands and these wireless systems may include cases in which some wireless systems use the same frequency band. When, for example, a wireless communication apparatus supports three wireless systems, a wireless system 1 may be a first frequency band and a wireless system 2 and a wireless system 3 may use a second frequency band that is different from the first frequency band.

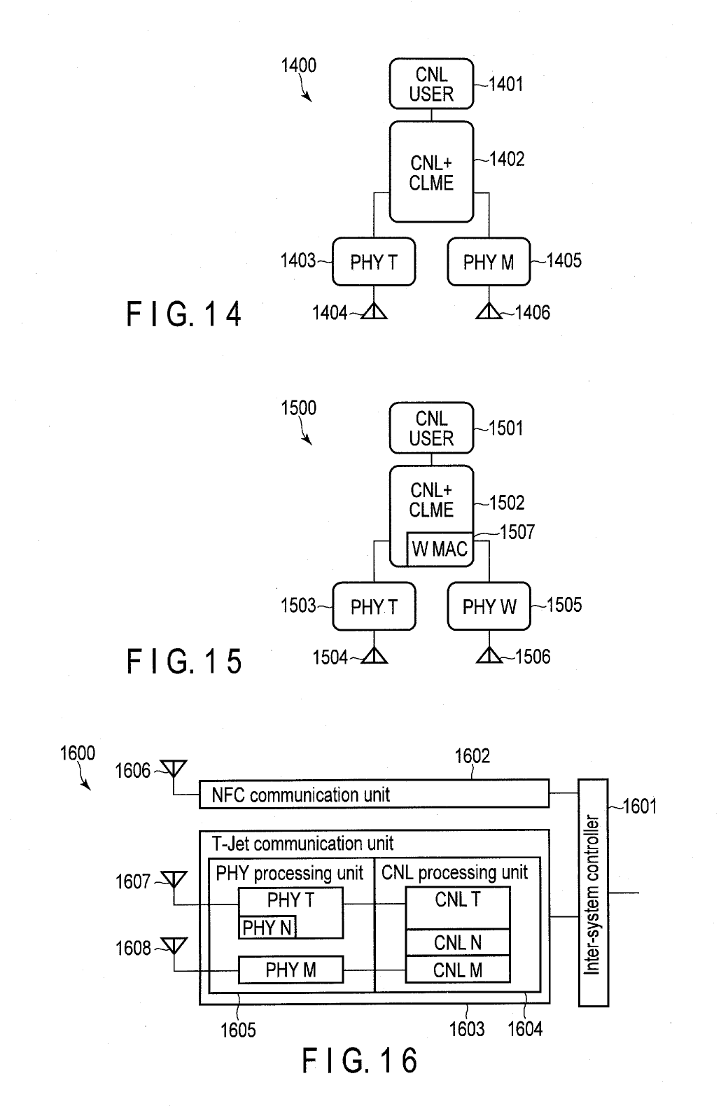

FIG. 14 schematically shows a wireless communication apparatus 1400 according to the present embodiment. The wireless communication apparatus 1400 includes a CNL User processing unit 1401, a CNL processing unit 1402 including CLME, a first PHY processing unit (PHY T) 1403 supporting the wireless system 1 and a second PHY processing unit (PHY M) 1405 supporting the wireless system 2. The CNL User processing unit 1401 and the CNL processing unit 1402 have functions similar to those of the CNL User processing unit 101 and the CNL processing unit 102 shown in FIG. 1. The first PHY processing unit 1403 communicates in the microwave band used by the current T-Jet. More specifically, an antenna (coupler for the current T-Jet) 1404 for microwave is connected to the first PHY processing unit 1403 and the first PHY processing unit 1403 transmits a signal in the microwave band via the antenna 1404. The second PHY processing unit 1405 communicates in the millimeter wave band. More specifically, an antenna 1406 for millimeter wave is connected to the second PHY processing unit 1405 and the second PHY processing unit 1405 transmits a signal in the millimeter wave band via the antenna 1406. As described in the third embodiment, functions may be added to the CNL processing unit 1402.

It is assumed below that the current T-Jet in the microwave band is a wireless system 1 and a wireless system in the millimeter wave band is a wireless system 2. The present embodiment can be realized by one of three techniques illustrated below.

A first technique performs connection processing in either one of the microwave band and the millimeter wave band. From the viewpoint of backward compatibility, the frequency band used for connection processing is desirably the frequency band of a wireless system which is a base system. If the wireless system 2 in the millimeter wave band is a succeeding system of the current T-Jet, the wireless communication apparatus 1400 performs connection processing in the microwave band and, after the connection processing is completed by the wireless system 2 being selected, exchanges data frames in the millimeter wave band. In this case, the CNL processing unit 1402 is connected to the first PHY processing unit 1403 to exchange signals related to frame transmission or frame reception until the connection processing is completed and, after the connection processing is completed, continues to be connected to the first PHY processing unit 1403 to exchange signals or is switched to the second PHY processing unit 1405 to exchange signals with the second PHY processing unit 1405.

In the first technique, any of the methods described in the first, second, fourth, fifth, and seventh embodiments may be used as the method of providing notification of supported wireless systems for connection processing.

In a second technique, either one of the microwave band and the millimeter wave band is used when receiving a C-Req frame in connection processing, i.e., in a standby state, and both of the microwave band and the millimeter wave band are used when transmitting a C-Req frame. Also, in the second technique, from the viewpoint of backward compatibility, the frequency band used for receiving a C-Req frame is desirably the frequency band of a wireless system which is a base system. If the wireless system 2 in the millimeter wave band is a succeeding system of the current T-Jet, the wireless communication apparatus 1400 receives a C-Req frame in the microwave band.

In the second technique, in consideration of the possibility of receiving a C-Acc frame in the millimeter wave band, the CNL processing unit 1402 waits to receive a C-Acc frame in the millimeter wave band for at least a predetermined period. For example, when transmitting a C-Req frame in the millimeter wave band, the CNL processing unit 1402 may wait for a C-Acc frame in the millimeter wave band for at least a predetermined period after transmitting the C-Req frame. If the predetermined period is the same as the period up to the transmission time of the next C-Req frame, the operation of the CNL processing unit 1402 after receiving a CNL_CONNECT.request primitive is the same in the second technique and a third technique described next. The second technique can reduce power consumption at least in a complete standby state before receiving a CNL_CONNECT.request primitive compared with a technique on standby in both frequency bands like the third technique and further can receive C-Req frames by both systems in the microwave band. Thus, the second technique is considered to be particularly effective in a migration period of the wireless system, for example, from the microwave band to the millimeter wave band. When connecting wireless communication apparatuses which support both of the wireless system 1 and the wireless system 2, connection processing is performed or started in the microwave band because a C-Req frame is on standby in the microwave band.

On the other hand, a wireless communication apparatus supporting only the wireless system 2 in the millimeter wave band can be considered as a communication peer. In the second technique, a C-Req frame may be transmitted also in the millimeter wave band for such a wireless communication apparatus. However, when a wireless communication apparatus supporting only the wireless system 2 and the wireless communication apparatus 1400 supporting both of the wireless system 1 and the wireless system 2 are wirelessly connected, and when the wireless communication apparatus 1400 has only a limited of time to receive a C-Req frame, the possibility for the wireless communication apparatus supporting only the wireless system 2 to become an initiator is low. In the present embodiment, a wireless communication apparatus supporting both of the wireless system 1 and the wireless system 2 is called a first wireless communication apparatus and a wireless communication apparatus supporting only the wireless system 2 is called a second wireless communication apparatus. The second wireless communication apparatus transmits and receives a C-Req frame in the millimeter wave band. A C-Req frame transmitted from the second wireless communication apparatus may not be received by the first wireless communication apparatus excluding a limited short period in which the first wireless communication apparatus accesses in the millimeter wave band to transmit a C-Req frame in the millimeter wave band and a period of waiting for the reception of a C-Acc frame after the C-Req frame transmission. To avoid the low possibility for the second wireless communication apparatus supporting only the wireless system 2 to become an initiator, for example, the access time of a C-Req frame for such first wireless communication apparatus may be made longer than the access time of a C-Req frame for the second wireless communication apparatus.

In the second technique, the CNL processing unit 1402 is mainly connected to the first PHY processing unit 1403 until connection processing is completed, is temporarily connected to the second PHY processing unit 1405 for transmission of a C-Req frame in the millimeter wave band to exchange signals related to frame transmission and frame reception, for example, and after the connection is established, continues to exchange signals with the first PHY processing unit 1403 or is switched to the second PHY processing unit 1405 exchange signals with the second PHY processing unit 1405 in accordance with the selected wireless system.

In the second technique, any of the methods described in the first, second, fourth, fifth, and seventh embodiments may be used as the notification method of the supported wireless systems for connection processing in the microwave band, and regarding transmission processing of a C-Req frame in the microwave band and in the millimeter wave band, the fourth embodiment may be applied with respect to the frequency axis, instead of the time axis. Regarding the reception of a C-Req frame, a C-Acc frame, and an ACK frame to a C-Acc frame, if the CNL processing unit 1402 can grasp whether notification comes from the first PHY processing unit 1403 or the second PHY processing unit 1405, the CNL processing unit 1402 can grasp wireless systems supported by the wireless communication apparatus that has transmitted the relevant frame. Therefore, although it was written that the CNL processing unit 1402 is mainly connected to the first PHY processing unit 1403 until connection processing is completed previously, for a C-Acc frame transmission, when the first wireless communication apparatus 1400 in a standby state recognizes that a communication partner candidate supports the wireless system 2 by a C-Req frame received via the wireless system 1, it can be transmitted via the second PHY processing unit 1405. By making the other first wireless communication apparatus 1400 which transmitted the C-Req frame to receive frames in both of the frequency bands, it can receive the C-Acc frame via the second PHY processing unit 1405. The other first wireless communication apparatus 1400 may then transmit an ACK frame to the C-Acc frame via the second PHY processing unit 1405.

The third technique uses both of the microwave band and the millimeter wave band when receiving a C-Req frame and transmitting a C-Req frame in connection processing. Also in the third technique, the fourth embodiment may be applied with respect to the frequency axis, instead of the time axis, regarding transmission processing of a C-Req frame. Regarding the reception of a C-Req frame, a C-Acc frame, and an ACK frame to a C-Acc frame, if the CNL processing unit 1402 can grasp whether notification comes from the first PHY processing unit 1403 or the second PHY processing unit 1405, the CNL processing unit 1402 can grasp wireless systems supported by the wireless communication apparatus that has transmitted the relevant frame.

In the third technique, the CNL processing unit 1402 connects to the first PHY processing unit 1403 and the second PHY processing unit 1405 alternately or simultaneously to exchange signals related to frame transmission and frame reception until connection processing is completed and, after the connection processing is completed, is connected to the PHY processing unit corresponding to the selected wireless system (the first PHY processing unit 1403 or the second PHY processing unit 1405).

In the first and second techniques, the wireless communication apparatus to be an initiator transmits an ACK frame in response to a C-Acc frame and makes a transition to the connected state. However, if the ACK frame is not correctly received by the wireless communication apparatus which will be a responder, connection processing is not completed at the wireless communication apparatus to be a responder and no transition to the connected state takes place and a C-Acc frame is retransmitted. Therefore, even if the PHY processing unit is switched by recognizing that a wireless system of a frequency band that is different from the frequency band in which frames are exchanged for connection processing, it is necessary for the wireless communication apparatus becoming an initiator to stay ready for reception by the wireless system in the frequency band before the transition until the transmission of the first data frame succeeds (that is, until an ACK frame in response to the data frame is received) after the transition to the connected state.

According to the ninth embodiment, as described above, also a wireless communication apparatus supporting a plurality of wireless systems using different frequency bands can establish wireless connection to another wireless communication apparatus supporting at least one of these wireless systems. By transmitting/receiving a frame related to connection corresponding to both of the wireless system 1 and the wireless system 2 at the first frequency, detection of another wireless communication apparatus supporting at least one of the wireless system 1 and the wireless system 2 is made easier. Further, by separating the frequency band for data exchange, interference can be reduced and also communication capacities can be increased.

### Tenth Embodiment

In the first to ninth embodiments, a case when T-Jet or a succeeding system thereof is used as the wireless system is described. In the tenth embodiment, a case where one wireless system is a system based on IEEE802.11/Wi-Fi wireless LAN will be described.

In the IEEE802.11 wireless LAN, in contrast to point-to-point communication of T-Jet, point-to-multipoint communication is assumed. Therefore, when a T-Jet wireless system and an IEEE802.11 wireless LAN wireless system are equally reviewed as selection candidates, it is necessary to introduce the concept of point-to-point communication also to the IEEE802.11 wireless LAN wireless system. The IEEE802.11 wireless LAN also has a mechanism to grasp on which authentication state the LAN is in with a wireless communication apparatus partner. In the present embodiment, the mechanism is used to limit the number of remote wireless communication apparatuses to one.

FIG. 15 schematically shows a wireless communication apparatus 1500 according to the tenth embodiment. As shown in FIG. 15, the wireless communication apparatus 1500 includes a CNL User processing unit 1501, a CNL processing unit 1502 including CLME, a first PHY processing unit (PHY W) 1505 supporting a wireless system 1, an antenna 1506 connected to the first PHY processing unit 1505, a second PHY processing unit (PHY T) 1503 supporting the wireless system 2, and an antenna 1504 connected to the second PHY processing unit 1503. A medium access control (MAC) processing unit 1507 of a wireless LAN is embedded in the CNL processing unit 1502. The medium access control processing unit of the wireless LAN is called a W MAC processing unit. The W MAC processing unit 1507 generates wireless LAN frames and performs access control via the first PHY processing unit 1505. The wireless LAN includes a MAC sublayer management entity (MLME) and the function thereof is assumed to be included in CLME in the CNL processing unit 1502. The PHY system differs between a wireless LAN system and a T-Jet system and thus, the ninth embodiment is referred to.

The communication area of the wireless LAN is wider than that of near field communication of a T-Jet system and thus, the wireless LAN is considered as the wireless system 1 as a base and the T-Jet system is considered as the wireless system 2. Performing connection processing by the wireless LAN system is considered to be preferable due to a difference of the communication area and in that case, the form of processing is similar to the first technique described in the ninth embodiment.

When a control signal related to the start instruction of connection settings is received from the CNL User processing unit 1501, the CNL processing unit 1502 generates a beacon frame of wireless LAN and periodically transmits the frame via the first PHY processing unit 1505. In the present embodiment, information element (IE) for notification of information showing other wireless systems that can be supported is defined. In the frame body of the beacon frame, IE which provides notification of the support of also the wireless system 2 of a T-Jet system is set.

In the present embodiment, a wireless communication apparatus 100 and a wireless communication apparatus 500 are assumed to be wireless communication apparatuses supporting wireless LAN and T-Jet wireless systems as shown in FIG. 15 and a wireless communication apparatus 200 is assumed to be a wireless communication apparatus only supporting the wireless LAN system.

In the wireless communication apparatus 200, even if a beacon frame containing the IE which notifies support of the T-Jet system is received, the MAC processing unit of the wireless LAN ignores the IE.

The wireless communication apparatus 500 recognizes that the wireless communication apparatus 100 also supports the wireless system 2 of a T-Jet system from the IE in a beacon frame. Subsequently, the wireless communication apparatus 500 attempts to connect to the wireless communication apparatus 100 by transmitting an authentication frame according to the connection processing procedure of the wireless LAN. In this case, the wireless communication apparatus 500 notifies that the wireless system 2 of a T-Jet system is also supported by setting the IE in a frame body of at least one of an authentication frames to be transmitted. Notification that the wireless system 2 is supported is desirably set in a frame in an initial stage of authentication processing of wireless LAN. As an example, notification that the wireless system 2 is supported is set in an association request frame. In another example, notification that the wireless system 2 is supported is set in an authentication frame.

When the wireless communication apparatus 100 desires to perform communication after transition to the wireless system 2, if, for example, it recognizes being within the communication area of the wireless system 2 based on the reception power of a received frame or the condition that being within the communication area can be expected, the wireless communication apparatus 100 performs connection processing to one wireless communication apparatus notifying that the wireless system 2 of a T-Jet system is supported in the frame body of a frame transmitted in the authentication processing. Therefore, when the transition to the wireless system 2 is carried on, the wireless communication apparatus 100 rejects an authentication type frame from the wireless communication apparatus 200 because the support of the wireless system 2 is not notified. If, for example, the wireless communication apparatus 100 reaches State 4 (authentication complete, association complete, 4-way handshake complete) in IEEE802.11 wireless LAN with the wireless communication apparatus 500, exchange of frames starting with a C-Req frame is attempted according to the connection processing procedure of the wireless system 2 and if the transition to the connected state takes place in the wireless system 2, the exchange of data frames in the wireless system 2 is started. To realize that, the CNL processing unit 1502 of the wireless communication apparatus 100 checks the reception status of the W MAC processing unit 1507 and when it is confirmed that State 4 is reached, the CNL processing unit 1502 generates a C-Req frame and instructs the PHY T processing unit 1503 to transmit the C-Req frame. If an identifier used in the wireless LAN system and an identifier used in the T-Jet system are different at a wireless communication apparatus which is a connection partner, it is desirable to enable the CNL processing unit 1502 to grasp the identifiers by, for example, setting the identifier of the T-jet system in the authentication type frame together with the above IE in advance. In this manner, the CNL processing unit 1502 can specify the identifier as the transmission destination to a C-Req frame and transmit the frame. In addition, the CNL processing unit 1502 can limit the C-Acc frame to be received to the frame transmitted from the wireless communication apparatus of the specified identifier. A CNL_ACCEPT.indication primitive may be output to the CNL User processing unit 1501 in the same manner as a conventional method. The CNL User processing unit 1501 obtains only information limited by the CNL processing unit 1502 and outputs a CNL_ACCEPT.response primitive according to the limited information.

In the present embodiment, after a CNL_CONNECT.request primitive is received from the CNL User processing unit 1501, connection processing of wireless LAN is first performed and if conditions are satisfied, a C-Req frame is transmitted to establish connection by the wireless system 2 of a T-Jet system. Therefore, the CNL User processing unit 1501 desirably sets the time-out period to wait for a CNL_ACCEPT.indication primitive longer than when connection processing in a conventional T-Jet system is simply performed.

According to the tenth embodiment, as described above, when a wireless system of IEEE802.11 wireless LAN and a wireless system of a T-Jet system are included in the wireless systems supported by a wireless communication apparatus, connection to another wireless communication apparatus supporting at least one of these wireless systems can be established.

### Eleventh Embodiment

A method of identifying and selecting the wireless system at the level of protocol information or version information of the data link layer or information of the physical layer by referring to NFC Forum Connection Handover 1.2 Technical Specification (hereinafter, abbreviated as [NFC handover]) will be described.

[NFC Handover] is a specification enabling to change (handover) the communication system to, for example, Wi-Fi, that is, IEEE802.11 wireless LAN or Bluetooth (registered trademark) after first establishing connection by NFC (Near Field Communication) that realizes secure communication in a non-contact proximity communication form.

However, in the case of Wi-Fi, the IEEE802.11 wireless LAN standard defines the MAC (Media Access Control) layer as a lower layer of the data link layer and the physical layer and a plurality of wireless systems are known at that level. Currently, known are 802.11a (in which the physical layer achieving max. 54 Mbps by using 5-GHz band is specified), 802.11b (in which the physical layer achieving max. 11 Mbps by using 2.4-GHz band is specified), 802.11e (in which the MAC layer corresponding to Quality of Service (QoS) is specified) or corresponding Wi-Fi multimedia (WMM) specifications as Wi-Fi Alliance, 802.11g (in which the physical layer achieving max. 54 Mbps by using 2.4-GHz band is specified), 802.11i (in which the MAC layer corresponding to security is specified) or corresponding Wi-Fi protected access (WPA) specifications as Wi-Fi Alliance, and 802.11n (in which the MAC and physical layers achieving max. 600 Mbps by using 2.4-GHz band or 5-GHz band is specified). Further extensions are also considered. Though backward compatibility is partially guaranteed, if performance should be pursued, it is desirable to use a system that is common between wireless communication apparatuses and of a higher version in detailed classification. A higher version is, in the case of the IEEE802.11 wireless LAN standard, basically a version with 802.11 suffixed with a letter of later alphabetical order. However, wireless communication cannot be performed if the target frequency bands are different and comparisons need to be made separately for the MAC layer and the physical layer. If, for example, one wireless communication apparatus supports 802.11a/b/g/n and the other wireless communication apparatus supports 802.11b/g, the optimal solution is to use 802.11g between the two wireless communication apparatuses. Incidentally, each extended standard of IEEE802.11 normally has required functions and optional functions provided therein. For example, 802.11n has 20 MHz as a required channel band in the definition of the physical layer portion and also has 40 MHz as an option. The number of transmitting/receiving antennas is specified in the range of 1 to 4 and an option is provided for the modulation and coding scheme (MCS) to extend the range of choice so that the transmission speed also has latitude in the supported range.

When wireless communication apparatuses are connected according to a protocol of normal IEEE802.11 (Wi-Fi), wireless communication is performed by mutually informing the other apparatus of supported systems up to detailed levels through MAC frames and selecting the optimal system.

However, handover to Wi-Fi in [NFC Handover] is intended for Wi-Fi Protected Setup (WPS) (see Wi-Fi Simple Configuration Technical Specification v2.0.2) and information currently exchanged over NFC and related to wireless LAN includes the support of Wi-Fi, network ID (IEEE802.11 Service Set IDentifier (SSID)), the authentication method (classification of the scheme concerning authentication related to encryption such as Open System, WPA-Personal, Shared Key, WPA-Enterprise, WPA2-Enterprise, and WPA2-Personal) and encryption method used in the network, the network key (used for encryption during communication), and the MAC address.

Such a notification level does not allow wireless communication to start quickly when the transition (handover) from NFC takes place and work (connection settings) to match fine supported system levels in the wireless system after transition needs to be done.

Thus, in the present embodiment, the corresponding detailed system level is made distinguishable by the version number and completion of settings for the wireless system after transition is enabled by setting the version number in messages exchanged over NFC.

For example, the TransferJet (T-Jet) system conforming to ECMA-398 shown in the above embodiments has a LiCC version of 1 (“0x01”). For example, a LiCC version of the N T-Jet system made faster in the microwave band is set to 2 (“0x02”) and LiCC version of the mmWave TransferJet (M T-Jet) system made faster in the millimeter wave band is set to 3 (“0x03”). The version numbers to identify systems are denoted by integers, but representations using the decimal point may also be used to implement more detailed classification in each system.

In a case of extension based on the format of [NFC Handover], an appropriate MIME (Multipurpose Internet Mail Extension) type as a character string for file identification is set in carrier type to indicate that the character string is connection information of a TransferJet device as NFC data exchange format (NDEF). Then, UID (Unique IDentifier) as the identifier of the wireless communication apparatus and the LiCC version information are set. That is, a TransferJet system as a major category of the handover candidate, the identifier of the wireless communication apparatus, and information of identifiers of system categories in the TransferJet system may be made notifiable via NDEF.

The method of performing connection processing via NFC by distinguishing detailed systems of the TransferJet system and using [NFC Handover] is described above and if supported detailed systems can be categorized in the same manner regarding the existing wireless LAN or Bluetooth, settings at the handover destination can be forwarded during NFC communication and carried out by the notification of the category information.

FIG. 16 shows a configuration example of a wireless communication apparatus 1600 according to the present embodiment. In the wireless communication apparatus 1600 shown in FIG. 16, an NFC communication unit 1602 and a TransferJet communication unit 1603 are connected via an inter-system controller 1601. When the NFC communication unit 1602 determines which wireless system of the TransferJet system to use, the inter-system controller 1601 subsequently selects the TransferJet communication unit 1603. More specifically, an element (one of CNL T, CNL N, and CNL M) of a CNL processing unit 1604 and a PHY processing unit 1605 corresponding to the determined TransferJet system will be used. For example, N T-Jet (version 2) is assumed to be positioned to have additional elements added (addition of the modulation methods) to the PHY elements of T-Jet (PHY T) in the PHY processing unit 1605 with respect to the current T-Jet (version 1) and to be configured to basically use the CNL elements of T-Jet (CNL T) in the CNL processing unit 1604 and to replace CNL T partially with the CNL elements for N T-Jet (CNL N). M T-Jet (version 3) has a circuit (elements) separate from T-Jet and N T-Jet provided in the PHY processing unit 1605 (PHY M) and is configured to basically use the CNL elements for T-Jet (CNL T) in the CNL processing unit 1604 and to replace CNL T partially with the CNL elements for N T-Jet (CNL N) or with the CNL elements for M T-Jet (CNL M). Therefore, when the version number is determined, communication is started by using an appropriate CNL/PHY element corresponding to the version. Proper use of the CNL/PHY element in detail is determined by the CNL processing unit 1604 by acquiring the determined wireless system (version) information from the inter-system controller 1601. From this point, the CNL processing unit 1604 shown in FIG. 16 includes an entity to manage CNL, that is, CLME (Connection Layer Management Entity).

The NFC communication unit 1602 transmits and receives frames via an antenna 1606. The TransferJet communication unit 1603 is provided with an antenna 1607 for the current T-Jet (version 1) and N T-Jet (version 2) and an antenna 1608 for M T-Jet (version 3). The TransferJet communication unit 1603 transmits and receives frames by using an antenna corresponding to the wireless system of TransferJet decided by the inter-system controller 1601.

In the present embodiment, the inter-system controller 1601 plays the role of receiving primitives or data from the upper layers (for example, the CNL User processing unit 101 in FIG. 1). When a primitive related to a start instruction of connection settings is received, the inter-system controller 1601 performs NDEF transmission by the NFC communication unit 1602. In this case, for example, depending on which message (a handover request message or handover selection message) of NDEF is transmitted, the role (an initiator or a responder) in point-to-point communication in TransferJet may automatically be decided. For example, the wireless communication apparatus that has transmitted a handover request message becomes an initiator. Alternatively, the role may be determined in the data exchange based on NDEF by entering request information about the role in point-to-point communication of TransferJet in NDEF in advance. When the NFC communication unit 1602 determines the system of TransferJet to which handover occurs and the role in point-to-point communication in TransferJet, the inter-system controller 1601 is notified of the determination signal from the NFC communication unit 1602 and upon receipt of the signal, the inter-system controller 1601 notifies the CNL processing unit 1604 of the TransferJet communication unit 1603 of the determined system, the role (an initiator or a responder) in point-to-point communication, and the identifier (UID) of the connection partner. The notified information may be held in a location (for example, a memory) from which the information can be read by the CNL processing unit 1604 while the inter-system controller 1601 notifies the CNL processing unit 1604 that the system is determined. Then, when a completion notification that a CNL/PHY element appropriate for the determined system is now in a state ready to exchange data frames, that is, being in the connected state is received from the CNL processing unit 1604 of the TransferJet communication unit 1603, if necessary, the inter-system controller 1601 passes data from the upper layer to the TransferJet communication unit 1603.

When the inter-system controller 1601 does not receive an instruction from the upper layer and does not pass data to the TransferJet communication unit 1603, it is desirable to always maintain the NFC communication unit 1602 on standby. Or like the start instruction of connection settings, after the inter-system controller 1601 receives a standby instruction from the upper layer, upon receipt of the instruction, the NFC communication unit 1602 may be put on standby.

In the current TransferJet, transition from the connection processing to the connected state corresponding to the final state occurs when a CNL_CONNECT.request primitive as the start instruction of connection settings is received at the CNL processing unit in a wireless communication apparatus at one side, an appropriate sequence of connection settings is exchanged with another wireless communication apparatus, and appropriate primitives related to connection are input from the upper layer at both sides. If, for example, the LiCC version is “1”, the CNL processing unit 1604 makes a transition to the connected state upon receipt of a CNL_ACCEPT.response from the upper layer and thereafter, when a C-Acc is received from a peer wireless communication apparatus in the connection processing, transmits an ACK before transmitting or receiving data frames. Therefore, even after the transition to the connected state, for the connection processing to be practically completed so that data frames can be exchanged, a frame exchange is needed. Thus, even if the inter-system controller 1601 makes the CNL processing unit 1604 to transit to the connected state, currently the initial state at a detailed level in the connected state is still a state waiting for reception of a C-Acc frame. To avoid being in a state waiting for a C-Acc frame, in the present embodiment, when the determined system, the role in point-to-point communication, and the identifier of the connection partner are notified from the inter-system controller 1601, instead of simply making a transition to the connected state, the CNL processing unit 1604 makes a transition to a sub-state in the connected state which is on standby for reception of a data transmission request from the upper layer or a data frame from the remote wireless communication apparatus.

According to the eleventh embodiment, as described above, switching from NFC to a wireless system of TransferJet becomes possible.

### Twelfth Embodiment

A wireless communication apparatus according to a twelfth embodiment is basically the same or similar to the wireless communication apparatus described in one of the above embodiments and further includes a buffer for communication based on each wireless system.

In a wireless communication apparatus 100 in FIG. 1, for example, the buffer may be provided in a CNL processing unit 102 or a memory (not shown) used by the CNL processing unit 102.

By providing the buffer, signals transmitted/received based on each wireless system can be stored. That is, for example, retransmission processing and external output processing of these signals can easily be realized.

### Thirteenth Embodiment

A wireless communication apparatus according to a thirteenth embodiment is basically the same or similar to the wireless communication apparatus described in one of the above embodiments and firmware operates in a CNL processing unit 102 and/or a CNL User processing unit 101. According to the present embodiment, changes of the wireless communication function can easily be realized by rewriting the firmware.

### Fourteenth Embodiment

A wireless communication apparatus according to a fourteenth embodiment is basically the same or similar to the wireless communication apparatus described in one of the above embodiments and a CNL processing unit 102 further includes a clock generator that generates a clock signal. The CNL processing unit 102 operates based on the clock signal from the clock generator. The CNL processing unit 102 can ensure synchronization of each piece of processing by operating based on the generated clock signal.

### Fifteenth Embodiment

A wireless communication apparatus according to a fifteenth embodiment is basically the same or similar to the wireless communication apparatus described in one of the above embodiments and further includes a power supply unit, a power supply controller, and a wireless power feed unit. The power supply controller is connected to the power supply unit and the wireless power feed unit to select one of the power supply unit and the wireless power feed unit as the power supply of the apparatus. According to the present embodiment, the power supply of a wireless communication unit is appropriately controlled, which enables a low power consumption operation.

### Sixteenth Embodiment

A wireless communication apparatus according to a sixteenth embodiment is basically the same or similar to the wireless communication apparatus described in one of the above embodiments and further includes a dynamic image compression/decompression unit. According to the present embodiment, compressed dynamic images can be transmitted and received compressed dynamic images can be decompressed easily.

### Seventeenth Embodiment

A wireless communication apparatus according to a seventeenth embodiment is basically the same or similar to the wireless communication apparatus described in one of the above embodiments and a CNL processing unit 102 or a PHY processing unit 103 further includes a light emitting diode (LED) unit or another lighting element. The LED unit lights up in a pattern in accordance with the operating state of the CNL processing unit 102 or the PHY processing unit 103 and/or the selected wireless system. Therefore, a user can easily be notified of the operating state of the CNL processing unit 102 or the PHY processing unit 103 and the selected wireless system.

### Eighteenth Embodiment

A wireless communication apparatus according to an eighteenth embodiment is basically the same or similar to the wireless communication apparatus described in one of the above embodiments and further includes a vibrator unit connected to a CNL processing unit 102 or a PHY processing unit 103. The vibrator unit vibrates in a pattern in accordance with the operating state of the CNL processing unit 102 or the PHY processing unit 103 and/or the selected wireless system. Therefore, a user can easily be notified of the operating state of the CNL processing unit 102 or the PHY processing unit 103 and the selected wireless system.

### Nineteenth Embodiment

A wireless communication apparatus according to a nineteenth embodiment is basically the same or similar to the wireless communication apparatus described in the tenth embodiment and further includes a switch. The switch connects a PHY T processing unit and a PHY W processing unit to an antenna. According to the present embodiment, communication can be performed by using an appropriate PHY T processing unit or PHY W processing unit in accordance with conditions while sharing the antenna.

According to a wireless communication apparatus according to at least one of the above-described embodiments, even if a CNL User processing unit does not grasp wireless systems that can be supported by a CNL processing unit, an appropriate wireless system used for data exchange with another wireless communication apparatus can be decided by, upon receipt of a trigger signal (CNL_CONNECT.request primitive) from the CNL User processing unit, a plurality of supported wireless systems being notified from the CNL processing unit that starts connection settings and a response from the other wireless communication apparatus being received.

According to at least one of the above-described embodiments, there is provided a wireless communication apparatus and method capable of selecting an appropriate wireless system used for communication with another wireless communication apparatus from a plurality of wireless systems that can be supported.

At least a portion of processing in each of the above embodiments can be realized by using a general-purpose computer as basic hardware. A program realizing the above processing may be provided by being stored in a computer readable storage medium. The program is stored in the storage medium as a file in an installable format or a file in an executable format. The storage medium is a magnetic disk, optical disk (CD-ROM, CD-R, DVD and so on), magneto-optical disk (MO and so on), or semiconductor memory. The storage medium may be any of the above as long as the program can be stored and the program can be read by a computer. The program realizing the above processing may be stored on a computer (server) connected to a network such as the Internet and downloaded to a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first processing unit configured to accept input of application data and generate a first control signal related to connection settings and transmission data based on the application data; and
a second processing unit supporting a plurality of wireless systems and configured to
generate a first frame related to connection processing based on a state in connection processing procedure when the first control signal is received from the first processing unit, the first frame being a frame which includes first information related to at least one of the plurality of wireless systems and in which a transmission destination is set based on the first control signal,
transmit the first frame by any of the plurality of wireless systems,
grasp, based on a second frame related to connection processing received from another wireless communication apparatus, a wireless system supported by the other wireless communication apparatus,
hold second information indicating the grasped wireless system,
output a second control signal indicating reception of the second frame to the first processing unit,
select a wireless system used for data exchange with the other wireless communication apparatus from the plurality of wireless systems based on the second information after completion of the connection processing procedure,
generate a data frame containing the transmission data, and
transmit the data frame by the selected wireless system.

2. The apparatus according to claim 1, wherein the plurality of wireless systems include a first wireless system using a first frequency band and a second wireless system using a second frequency band different from the first frequency band, and
the second processing unit performs transmission of the first frame and reception of the second frame in the first frequency band.

3. The apparatus according to claim 1, wherein the plurality of wireless systems include a first wireless system and a second wireless system, and
the second processing unit generates the first frame in which the first information indicating support of the second wireless system is set in a field undefined in the first wireless system.

4. The apparatus according to claim 1, wherein the first frame is a connection request frame and the second frame is a connection response frame in response to the connection request frame.

5. The apparatus according to claim 4, wherein the plurality of wireless systems include a first wireless system and a second wireless system, and
the second processing unit generates a first connection request frame corresponding to the first wireless system and a second connection request frame corresponding to the second wireless system when the first control signal is received from the first processing unit, transmits the first connection request frame by the first wireless system and waits for reception of a connection response frame in response to the first connection request frame, transmits the second connection request frame by the second wireless system and waits for reception of a connection response frame in response to the second connection request frame, determines whether the connection response frame corresponds to the first wireless system or the second wireless system, and decides the wireless system used for the data exchange based on the determination.

6. The apparatus according to claim 4, wherein the plurality of wireless systems include a first wireless system and a second wireless system, and
the second processing unit generates a first connection request frame corresponding to the first wireless system when the first control signal is received from the first processing unit, transmits the first connection request frame repeatedly by the first wireless system and waits for the reception of a first connection response frame in response to the first connection request frame in a first predetermined period, sets the first wireless system as the wireless system used for the data exchange if the first connection response frame is received in the first predetermined period, generates a second connection request frame corresponding to the second wireless system if the first connection response frame fails to be received in the first predetermined period, transmits the second connection request frame repeatedly by the second wireless system and waits for the reception of a second connection response frame in response to the second connection request frame in a second predetermined period, and sets the second wireless system as the wireless system used for the data exchange if the second connection response frame is received in the second predetermined period.

7. The apparatus according to claim 1, wherein the second frame is a connection request frame and the first frame is a connection response frame in response to the connection request frame.

8. The apparatus according to claim 7, wherein the plurality of wireless systems include a first wireless system and a second wireless system having backward compatibility with the first wireless system, and
the second processing unit ignores a connection request frame corresponding to the first wireless system if the connection request frame corresponding to the first wireless system is received from the other wireless communication apparatus after a connection request frame corresponding to the second wireless system is received from the other wireless communication apparatus.

9. A wireless communication method comprising:
accepting, at a first processing unit, input of application data;
generating, at the first processing unit, a first control signal related to connection settings and transmission data based on the application data;
generating, at a second processing unit supporting a plurality of wireless systems, a first frame related to connection processing based on a state in connection processing procedure when the first control signal is received from the first processing unit, the first frame being a frame which includes first information related to at least one of the plurality of wireless systems and in which a transmission destination is set based on the first control signal;
transmitting, at the second processing unit, the first frame by any of the plurality of wireless systems;
grasping, at the second processing unit, based on a second frame related to connection processing received from another wireless communication apparatus, a wireless system supported by the other wireless communication apparatus;
holding, at the second processing unit, second information indicating the grasped wireless system;
outputing, at the second processing unit, a second control signal indicating reception of the second frame to the first processing unit;
selecting, at the second processing unit, a wireless system used for data exchange with the other wireless communication apparatus from the plurality of wireless systems based on the second information after completion of the connection processing procedure;
generating, at the second processing unit, a data frame containing the transmission data; and
transmitting, at the second processing unit, the data frame by the selected wireless system.

10. The method according to claim 9, wherein the plurality of wireless systems include a first wireless system using a first frequency band and a second wireless system using a second frequency band different from the first frequency band, and
transmission of the first frame and reception of the second frame are performed in the first frequency band at the second processing unit.

11. The method according to claim 9, wherein the plurality of wireless systems include a first wireless system and a second wireless system, and
the generating the first frame comprising generating the first frame in which the first information indicating support of the second wireless system is set in a field undefined in the first wireless system.

12. The method according to claim 9, wherein the first frame is a connection request frame and the second frame is a connection response frame in response to the connection request frame.

13. The method according to claim 12, wherein the plurality of wireless systems include a first wireless system and a second wireless system,
the generating the first frame comprising generating a first connection request frame corresponding to the first wireless system and a second connection request frame corresponding to the second wireless system,
the transmitting the first frame comprising transmitting the first connection request frame by the first wireless system and transmitting the second connection request frame by the second wireless system,
the selecting comprising determining whether the connection response frame corresponds to the first wireless system or the second wireless system and deciding the wireless system used for the data exchange based on the determination.

14. The method according to claim 12, wherein the plurality of wireless systems include a first wireless system and a second wireless system, and
the generating the first frame comprising generating a first connection request frame corresponding to the first wireless system when the first control signal is received from the first processing unit,
the transmitting the first frame comprising transmitting the first connection request frame repeatedly by the first wireless system and waits for the reception of a first connection response frame in response to the first connection request frame in a first predetermined period,
the selecting comprising setting the first wireless system as the wireless system used for the data exchange if the first connection response frame is received in the first predetermined period,
generating the first frame further comprising generates a second connection request frame corresponding to the second wireless system if the first connection response frame fails to be received in the first predetermined period,
the transmitting the first frame further comprising transmitting the second connection request frame repeatedly by the second wireless system and waits for the reception of a second connection response frame in response to the second connection request frame in a second predetermined period, and
the selecting comprising setting the second wireless system as the wireless system used for the data exchange if the second connection response frame is received in the second predetermined period.

15. The method according to claim 9, wherein the second frame is a connection request frame and the first frame is a connection response frame in response to the connection request frame.

16. The method according to claim 15, wherein the plurality of wireless systems include a first wireless system and a second wireless system having backward compatibility with the first wireless system, and
the method further comprising ignoring, at the second processing unit, a connection request frame corresponding to the first wireless system if the connection request frame corresponding to the first wireless system is received from the other wireless communication apparatus after a connection request frame corresponding to the second wireless system is received from the other wireless communication apparatus.
